(19) United States
(12) Patent Application Publication
(10) Pub. No.: US 2025/0097913 A1
(43) Pub. Date: Mar. 20, 2025

(54) WIRELESS COMMUNICATION METHOD AND APPARATUSES, DEVICE, AND STORAGE MEDIUM

(71) Applicant: GUANGDONG OPPO MOBILE TELECOMMUNICATIONS CORP., LTD., Dongguan (CN)

(72) Inventor: Jing XU, Dongguan (CN)

(21) Appl. No.: 18/968,922

(22) Filed: Dec. 4, 2024

Related U.S. Application Data
(63) Continuation of application No. PCT/CN2022/119735, filed on Sep. 19, 2022.

(51) Int. Cl. H04W 72/0446; H04W 72/0453

(52) U.S. Cl. CPC H04W 72/0446; H04W 72/0453

(57) ABSTRACT

Provided is a wireless communication method, including that, a terminal device receives first configuration information transmitted by a network device. The first configuration information is used to indicate a first time domain resource, and the first time domain resource includes one or more time units, each time unit including a first frequency domain part in frequency domain. For any one time unit in the first time domain resource, a transmission direction of the first frequency domain part is different from a transmission direction of the time unit configured by second configuration information, the second configuration information being used to configure a transmission direction for each of time units in one period.

### CROSS-REFERENCE TO RELATED APPLICATION

This application is a continuation of International Patent Application No. PCT/CN2022/119735 filed on Sep. 19, 2022, the disclosure of which is incorporated herein by reference in its entirety.

### BACKGROUND

For a Time Division Duplex (TDD) system, uplink-downlink configuration is used to configure/indicate the transmission direction for each slot/symbol. The transmission direction of each slot/symbol includes uplink, downlink or a flexible transmission direction. When the transmission directions of slot/symbols are configured by the uplink-downlink configuration, using the slot/symbols as indicated objects, one slot or symbol is used only for uplink transmission or downlink transmission, which makes low efficiency of the resource utilization.

### SUMMARY

Embodiments of the present disclosure relate to the technical field of mobile communications, and in particular provide a wireless communication method and apparatus, a device, and a storage medium.

A wireless communication method provided by the embodiments of the present disclosure includes the following operation.

A terminal device receives first configuration information transmitted by a network device. The first configuration information is used to indicate a first time domain resource. The first time domain resource includes one or more time units, each time unit including a first frequency domain part in frequency domain. Herein, for any one time unit included in the first time domain resource, a transmission direction of the first frequency domain part is different from a transmission direction of the time unit configured by second configuration information. The second configuration information is used to configure a transmission direction for each time unit in one period.

A wireless communication apparatus provided by the embodiments of the present disclosure includes a transceiver.

The transceiver is configured to receive first configuration information transmitted by a network device. The first configuration information is used to indicate a first time domain resource. The first time domain resource includes one or more time units, each time unit including a first frequency domain part in frequency domain. Herein, for any one time unit included in the first time domain resource, a transmission direction of the first frequency domain part is different from a transmission direction of the time unit configured by second configuration information. The second configuration information is used to configure a transmission direction for each time unit in one period.

A wireless communication apparatus provided by the embodiments of the present disclosure includes a transceiver.

The transceiver is configured to transmit first configuration information to a terminal device. The first configuration information is used to indicate a first time domain resource. The first time domain resource includes one or more time units, each time unit including a first frequency domain part in frequency domain. Herein, for any one time unit included in the first time domain resource, a transmission direction of the first frequency domain part is different from a transmission direction of the time unit configured by second configuration information. The second configuration information is used to configure a transmission direction for each time unit in one period.

According to the above technical solutions, the network device indicates, through the first configuration information, the first time domain resource that includes the first frequency domain part in frequency domain, and for any one time unit in the first time domain resource, the transmission direction of the first frequency domain part configured by the first configuration information is able to be different from the transmission direction for the time unit configured by the second configuration information. In this way, different transmission directions can be supported for different frequency domain resources within one time unit, so that configuration of the frequency domain resources in different transmission directions can be implemented in one time unit. Moreover, one time unit can include, in frequency domain, frequency domain resources with different transmission directions, and thus the reception and transmission of data can be performed simultaneously in one time unit, thereby improving resource utilization.

### BRIEF DESCRIPTION OF THE DRAWINGS

The accompanying drawings described herein are intended to provide a further understanding of the present disclosure, which constitute a part of the present disclosure. The schematic embodiments of the present disclosure and the description thereof are intended to explain the present disclosure, which do not constitute an undue limitation of the present disclosure.

FIG. 1 is a schematic diagram of an application scenario according to an embodiment of the present disclosure.

FIG. 2A is a schematic diagram of an uplink part according to an embodiment of the present disclosure.

FIG. 2B is a schematic diagram of an uplink part according to an embodiment of the present disclosure.

FIG. 3 is an optional schematic flowchart of a wireless communication method according to an embodiment of the present disclosure.

FIG. 4 is an optional schematic flowchart of a wireless communication method according to an embodiment of the present disclosure.

FIG. 5 is an optional schematic flowchart of a wireless communication method according to an embodiment of the present disclosure.

FIG. 6 is an optional schematic diagram of transmission directions of time units indicated by second configuration information according to an embodiment of the present disclosure.

FIG. 7A is an optional schematic diagram of a transmission direction of a target time unit according to an embodiment of the present disclosure.

FIG. 7B is an optional schematic diagram of a transmission direction of a target time unit according to an embodiment of the present disclosure.

FIG. 7C is an optional schematic diagram of a transmission direction of a target time unit according to an embodiment of the present disclosure.

FIG. 7D is an optional schematic diagram of a transmission direction of a target time unit according to an embodiment of the present disclosure.

FIG. 7E is an optional schematic diagram of a transmission direction of a target time unit according to an embodiment of the present disclosure.

FIG. 7F is an optional schematic diagram of a transmission direction of a target time unit according to an embodiment of the present disclosure.

FIG. 7G is an optional schematic diagram of a transmission direction of a target time unit according to an embodiment of the present disclosure.

FIG. 7H is an optional schematic diagram of a transmission direction of a target time unit according to an embodiment of the present disclosure.

FIG. 7I is an optional schematic diagram of a transmission direction of a target time unit according to an embodiment of the present disclosure.

FIG. 8 is an optional schematic diagram of a wireless communication method according to an embodiment of the present disclosure.

FIG. 9 is an optional schematic diagram of transmission directions of slots according to an embodiment of the present disclosure.

FIG. 10 is an optional schematic diagram of transmission directions of slots according to an embodiment of the present disclosure.

FIG. 11 is an optional schematic diagram of transmission directions of slots according to an embodiment of the present disclosure.

FIG. 12 is an optional schematic diagram of transmission directions of slots according to an embodiment of the present disclosure.

FIG. 13 is an optional schematic diagram of transmission directions of slots according to an embodiment of the present disclosure.

FIG. 14 is an optional schematic diagram of transmission directions of slots according to an embodiment of the present disclosure.

FIG. 15 is an optional schematic diagram of a structure of a wireless communication apparatus according to an embodiment of the present disclosure.

FIG. 16 is an optional schematic diagram of a structure of a wireless communication apparatus according to an embodiment of the present disclosure.

FIG. 17 is a schematic structural diagram of a communication device according to an embodiment of the present disclosure.

FIG. 18 is a schematic structural diagram of a chip according to an embodiment of the present disclosure.

FIG. 19 is a schematic block diagram of a communication system according to an embodiment of the present disclosure.

### DETAILED DESCRIPTION

Hereinafter, the technical solutions in the embodiments of the present disclosure will be described with reference to the accompanying drawings in the embodiments of the present disclosure. It is apparent that the described embodiments are part of the embodiments of the present disclosure, but not all of the embodiments. Based on the embodiments in the present disclosure, all other embodiments obtained by those skilled in the art without creative work fall within the scope of protection of the present disclosure.

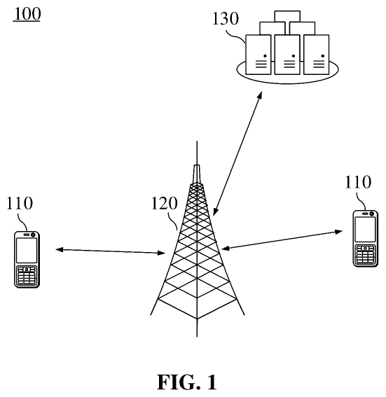

FIG. 1 is a schematic diagram of an application scenario according to an embodiment of the present disclosure.

As illustrated in FIG. 1, the communication system 100 may include terminal devices 110 and a network device 120. The network device 120 may communicate with the terminal devices 110 through an air interface. Multi-service transmission is supported between the terminal devices 110 and the network device 120.

It should be understood that the embodiments of the present disclosure are only illustrated with reference to the communication system 100, but the embodiments of the present disclosure are not limited thereto. That is, the technical solutions of the embodiments of the present disclosure may be applied to various communication systems, such as a Long Term Evolution (LTE) system, an LTE TDD, a Universal Mobile Telecommunication System (UMTS), an Internet of Things (IoT) system, a Narrow Band Internet of Things (NB-IoT) system, an enhanced Machine-Type Communications (eMTC) system, a 5G communication system (also referred to as a New Radio (NR) communication system), or future communication systems, etc.

In the communication system 100 illustrated in FIG. 1, the network device 120 may be an access network device that communicates with the terminal devices 110. The access network device may provide communication coverage for a particular geographic area and may communicate with terminal devices 110 (for example, User Equipment (UE)) located within the coverage area.

The network device 120 may be an Evolutional Node B (eNB or eNodeB) in a LTE system, a Next Generation Radio Access Network (NG RAN) device, a base station (gNB) in an NR system, a wireless controller in a Cloud Radio Access Network (CRAN), a relay station, an access point, a vehicle-mounted device, a wearable device, a hub, a switch, a bridge, a router, or a network device in a future evolved Public Land Mobile Network (PLMN), etc.

The terminal device 110 may be any terminal device, which includes, but not limited to, a terminal device that is connected to the network device 120 or other terminal devices by using a wired or wireless mode.

For example, the terminal device 110 may refer to an access terminal, a UE, a subscriber unit, a subscriber station, a mobile station, a mobile stage, a remote station, a remote terminal, a mobile device, a user terminal, a terminal, a wireless communication device, a user agent, or a user device. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device with wireless communication functionality, a computing device or other processing device connected to a wireless modem, a vehicle-mounted device, a wearable device, a terminal device in a 5G network or a terminal device in a future evolution network, or the like.

The terminal devices 110 may be used for Device to Device (D2D) communication.

The wireless communication system 100 may further include a core network device 130 that communicates with the base station. The core network device 130 may be a 5G Core (5GC) device, for example, an Access and Mobility Management Function (AMF), an Authentication Server Function (AUSF), a User Plane Function (UPF), or a Session Management Function (SMF). In some embodiments, the core network device 130 may also be an Evolved Packet Core (EPC) device of an LTE network, for example, a Session Management Function+Core Packet Gateway (SMF+PGW-C) device. It should be understood that the SMF+PGW-C may simultaneously implement functions that the SMF and the PGW-C can achieve. In the process of network evolution, the above core network devices may be named differently, or may be formed as a new network entity(s) by dividing functions of the core network, which is not limited by the embodiments of the present disclosure.

The respective functional units in the communication system 100 may also establish a connection between each other through a next generation (NG) network interface to achieve communication.

For example, the terminal device establishes an air interface connection with the access network device through a Uu interface, where the air interface connection is used for transmitting user plane data and control plane signaling. The terminal device may establish a control plane signaling connection with the AMF through a NG interface 1 (N1). The access network device, such as a next generation radio access base station (gNB), may establish a user plane data connection with the UPF through an NG interface 3 (N3). The access network device may establish a control plane signaling connection with the AMF through a NG interface 2 (N2). The UPF may establish a control plane signaling connection with the SMF through a NG interface 4 (N4). The UPF may interact with the data network user plane data through a NG interface 6 (N6). The AMF may establish a control plane signaling connection with the SMF through a NG interface 11 (N11). The SMF may establish a control plane signaling connection with the PCF through a NG interface 7 (N7).

FIG. 1 exemplarily illustrates one base station, one core network device, and two terminal devices. In some embodiments, the wireless communication system 100 may include multiple base station devices, and the coverage area of each base station may include another number of terminal devices, which is not limited in the embodiments of the present disclosure.

It should be noted that FIG. 1 only illustrates a system applicable to the present disclosure by way of example. Of course, the methods illustrated in the embodiments of the present disclosure may also be applied to other systems. Furthermore, the terms “system” and “network” are often used interchangeably herein. Herein, the term “and/or” is only used for describing an association relationship between associated objects, which represents that there may be three relationships. For example, A and/or B, may represent that A exists alone, A and B exist simultaneously, or B exists alone. In addition, the character “/” in the present disclosure generally represents that there is an “or” relationship between the associated objects. It should also be understood that the “indication” mentioned in the embodiments of the present disclosure may be a direct indication, an indirect indication, or may represent that there is an association relationship. For example, A indicates B, which may represent that A directly indicates B, for example, B may be obtained by A. It may also represent that A indicates B indirectly, for example, A indicates C, and B may be obtained through C. It may also represent that there is an association relationship between A and B. It should also be understood that “correspondence” mentioned in the embodiments of the present disclosure may represent that there is a direct correspondence or indirect correspondence between the two objects, may represent that there is an association relationship between the two objects, or may represent a relationship between indicating and being indicated, configuring and being configured, or the like. It should also be understood that the “predefined” or “predefined rules” mentioned in the embodiments of the present disclosure may be implemented by storing corresponding codes, tables, or other methods that may be used to indicate relevant information in advance in devices (for example, including terminal devices and network devices), and specific implementations are not limited in the present disclosure. For example, “predefined” may refer to being defined in the protocol. It should also be understood that in the embodiments of the present disclosure, the “protocol” may refer to a standard protocol in the field of communications, which may include, for example, an LTE protocol, an NR protocol, and related protocols applied in future communication systems, and the present disclosure is not limited thereto.

In order to facilitate understanding of the technical solutions of the embodiments of the present disclosure, the related art of the embodiments of the present disclosure will be described below. The related art below may be arbitrarily combined with the technical solutions of the embodiments of the present disclosure as optional solutions, and all of them belong to the scope of protection of the embodiments of the present disclosure.

### Uplink-Downlink Configuration

For the TDD system, the uplink-downlink-configuration is used to configure/indicate the transmission direction of each symbol. In the related art, it is mentioned that one or more of three modes of TDD-uplink-downlink common configuration (TDD-UL-DL-ConfigCommon), TDD-uplink-downlink dedicated configuration (TDD-UL-DL-ConfigDedicated) and Slot Format Indication (SFI) are used to indicate the transmission direction of each symbol, and there are three types of transmission directions of symbol including uplink, downlink and a flexible transmission direction. The TDD-UL-DL-ConfigCommon and TDD-UL-DL-ConfigDedicated are higher-layer signaling, where the former is configured for a cell and is transmitted to all users in the cell through broadcast information, and the latter is independently transmitted to users who need it through RRC signaling.

Information elements of TDD-UL-DL-ConfigCommon are illustrated as follows:

| | |
|---|---|
| TDD-UL-DL-ConfigCommon:: = | SEQUENCE { |
| referenceSubcarrierSpacing | SubcarrierSpacing, |
| pattern1 | TDD-UL-DL-Pattern, |
| pattern 2 | TDD-UL-DL-Pattern |

OPTIONAL,--Need R
...
}

| | |
|---|---|
| TDD-UL-DL-Pattern :: = | SEQUENCE { |

| | |
|---|---|
| dl-UL-TransmissionPeriodicity | ENUMERATED {ms0p5, ms0p625, ms1, ms1p25, ms2, |

ms2p5, ms5, ms10},

| | |
|---|---|
| nrofDownlinkSlots | INTEGER (0.. maxNrofSlots), |
| nrofDownlinkSymbols | INTEGER (0.. maxNrofSymbols-1), |
| nrofUplinkSlots) | INTEGER (0.. maxNrofSlots), |
| nrofUplinkSymbols) | INTEGER (0.. maxNrofSymbols-1), |

```
  ...,
  }
```

Information elements of TDD-UL-DL-ConfigDedicated are illustrated as follows:

| | |
|---|---|
| TDD-UL-DL-ConfigDedicated :: = | SEQUENCE { |

| | |
|---|---|
| slotSpecificConfigurationsToAddModList | SEQUENCE (SIZE (1.. maxNrofSlots)) OF |

| | |
|---|---|
| TDD-UL-DL-SlotConfig | OPTIONAL, -- Need N |

| | |
|---|---|
| slotSpecificConfigurationsToReleaseList | SEQUENCE (SIZE (1.. maxNrofSlots)) OF |

| | |
|---|---|
| TDD-UL-DL-SlotIndex | OPTIONAL, -- Need N |

...
}

| | |
|---|---|
| TDD-UL-DL-SlotConfig :: = | SEQUENCE { |

| | |
|---|---|
| slotIndex | TDD-UL-DL-SlotIndex, |
| symbols | CHOICE { |
| allDownlink | NULL, |
| allUplink | NULL, |
| explicit | SEQUENCE { |

| | |
|---|---|
| nrofDownlinkSymbols | INTEGER (1.. maxNrofSymbols-1) |
| nrofUplinkSymbols | INTEGER (1.. maxNrofSymbols-1) |

```
    }
  }
}
```

| | |
|---|---|
| TDD-UL-DL-SlotIndex :: = | INTEGER (0.. maxNrofSlots-1). |

The SFI indicates the transmission direction of each slot/symbol in each carrier through Downlink Control Information (DCI) (which may also be referred to as a group common DCI) of a user group: DCI format 2_0. Since SFI is a dynamic signaling, it may indicate a semi-statically configured slot/symbol as a determined transmission direction, i.e., uplink or downlink.

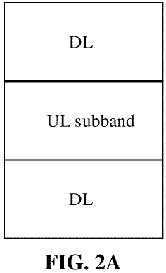

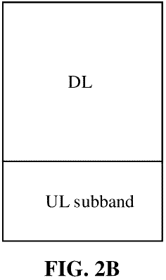

In order to improve resource utilization, X Division Duplexing (XDD) technology is introduced, where the transmission and reception of data can be performed simultaneously on different subbands of the same subframe. As illustrated in FIG. 2A, a middle subband of one downlink (DL) slot is configured to be an uplink (UL) subband. As illustrated in FIG. 2B, a part of subbands of one DL slot is configured to be an UL subband. The uplink subbands in FIG. 2A and FIG. 2B may also be referred to as uplink parts. The XDD is mainly used on the base station side. The terminal side still maintains the current state, that is, only transmission or reception of data is supported in one subframe. The slot or symbol where reception and transmission of data can be performed simultaneously based on different subbands may be referred to as a slot/symbol supporting subband Full Duplex (SBFD) or Subband non-Overlapping Full Duplex (SBFD).

Regarding SBFD, at the 3GPP RAN related meeting, the following agreements were made.

A semi-static configuration is mainly adopted for the indication of the position of the SBFD subband.

For the indication of the position of the SBFD subband, i.e., the SBFD configuration, a semi-static configuration is considered preferentially, or even only a semi-static configuration may be adopted.

In addition, the semi-static configuration is adopted for the time domain position of the SBFD, but a dynamic configuration is already supported by the TDD frame structure. The configured results from the two configurations may be different, resulting in a conflict between the configured results, for example, a slot/symbol configured with the SBFD is dynamically indicated as an uplink slot/symbol simultaneously. In addition, for a flexible slot/symbol, when it is configured with an uplink part, that is, an uplink subband, whether it is considered as an SBFD slot/symbol or an uplink slot/symbol is a problem.

In order to facilitate understanding of the technical solutions of the embodiments of the present disclosure, the technical solutions of the present disclosure will be described in detail below with reference to specific embodiments. The above related arts may be arbitrarily combined with the technical solutions of the embodiments of the present disclosure as optional solutions, and all of them belong to the scope of protection of the embodiments of the present disclosure. Embodiments of the present disclosure include at least some of the following contents.

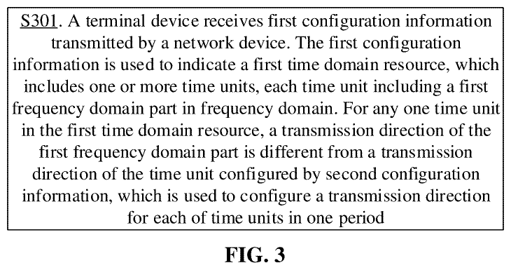

An optional processing flow of the wireless communication method provided by an embodiment of the present disclosure is applied to a terminal device. As illustrated in FIG. 3, the method includes the following operation S301.

In operation S301, the terminal device receives first configuration information transmitted by a network device. The first configuration information is used to indicate a first time domain resource. The first time domain resource includes one or more time units, each of time unit including a first frequency domain part in frequency domain. Herein, for any one time unit included in the first time domain resource, a transmission direction of the first frequency domain part is different from a transmission direction of the time unit configured by second configuration information. The second configuration information is used to configure a transmission direction for each time unit in one period.

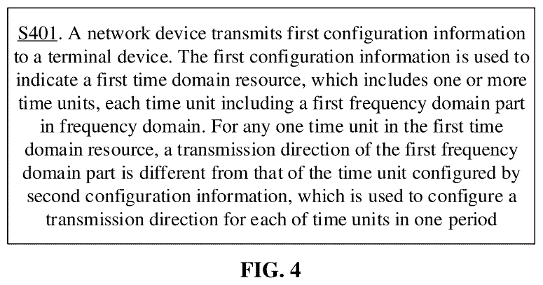

An optional processing flow of the wireless communication method provided by an embodiment of the present disclosure is applied to a network device. As illustrated in FIG. 4, the method includes the following operation S401.

In operation S401, the network device transmits first configuration information to a terminal device. The first configuration information is used to indicate a first time domain resource. The first time domain resource includes one or more time units, each time unit including a first frequency domain part in frequency domain. Herein, for any one time unit included in the first time domain resource, a transmission direction of the first frequency domain part is different from a transmission direction of the time unit configured by second configuration information. The second configuration information is used to configure a transmission direction for each time unit in one period.

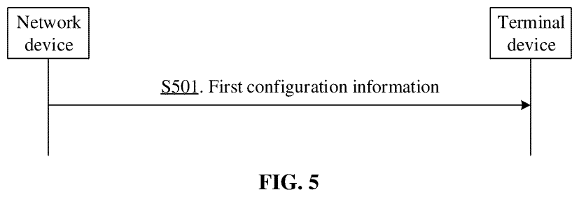

An optional processing flow of the wireless communication method provided by an embodiment of the present disclosure is applied to a wireless communication system including a network device and a terminal device. As illustrated in FIG. 5, the method includes the following operation S501.

In operation S501, the network device transmits the first configuration information to the terminal device.

The first configuration information is used to indicate a first time domain resource. The first time domain resource includes one or more time units, each of which includes the first frequency domain part in frequency domain. Herein, for any one time unit included in the first time domain resource, a transmission direction of the first frequency domain part is different from a transmission direction of the time unit configured by the second configuration information. The second configuration information is used to configure a transmission direction for each time unit in one period.

Hereinafter, the wireless communication methods illustrated in FIG. 3, FIG. 4, and FIG. 5 will be described.

The first configuration information is used to indicate the first time domain resource. In frequency domain, each of the one or more time units of the first time domain resource includes the first frequency domain part. The first frequency domain part may be understood as a part of subbands of one time unit. It may be understood that the first configuration information indicates a time unit including the first frequency domain part in the frequency domain, and the time unit indicated by the first configuration information constitutes the first frequency domain resource.

In an example, each of the slot A and the slot B includes the first frequency domain part in frequency domain, the first configuration information transmitted by the network device indicates the slot A and the slot B, and the terminal device determines that each of the slot A and the slot B includes the first frequency domain part in frequency domain based on the received first configuration information.

In some embodiments, the first configuration information is used to indicate the first frequency domain part and the first time domain resource, and the terminal device determines that each of the one or more time units included in the first time domain resource includes the first frequency domain part in frequency domain.

In some embodiments, the first frequency domain part is less than or equal to a reception bandwidth or a transmission bandwidth supported by the terminal device, in the frequency domain.

In some embodiments, the first frequency domain part is less than or equal to a bandwidth of a Bandwidth Part (BWP) supported by the terminal device, in the frequency domain.

In some embodiments, the first frequency domain part is used for uplink transmission or downlink transmission.

It may be understood that, for a time unit in the first time domain resource, the first configuration information is used to configure a transmission direction of the first frequency domain part, and the transmission direction of the second frequency domain part, which is a frequency domain part other than the first frequency domain part, is different from the transmission direction of the first frequency domain part.

The first frequency domain part for uplink transmission may be referred to as an uplink part, and the first frequency domain part for downlink transmission may be referred to as a downlink part. If the first frequency domain part is used for uplink transmission, then the transmission direction of the first frequency domain part is uplink. If the first frequency domain part is used for downlink transmission, then the transmission direction of the first frequency domain part is downlink. In the embodiments of the present disclosure, the first frequency domain part on one time unit in the first frequency domain resource is used for uplink transmission or downlink transmission, and the transmission directions of the first frequency domain parts included in different time units are the same or different. The first time domain resources including the first frequency domain parts with different transmission directions may be indicated by different first configuration information.

In an example, when the first configuration information indicates that the time units 1 to 4 include uplink parts in the frequency domain, the first time domain resource includes the time units 1 to 4.

In an example, when the first configuration information indicates that the time units 5 to 7 include downlink parts in the frequency domain, the first time domain resource includes the time units 5 to 7.

In an example, the terminal device receives two pieces of first configuration information: first configuration information A and first configuration information B. The first configuration information A indicates that the time units 1 to 4 include uplink parts in the frequency domain, and the first configuration information B indicates that the time units 5 to 7 include downlink parts in the frequency domain. In this case, the first time domain resource includes the time units 1 to 7.

The second configuration information is used to configure the transmission directions of respective time units in one period. For one time unit, the transmission direction configured by the second configuration information may include one of uplink, downlink, and a flexible transmission direction. It may be understood that, for one time unit, the second configuration information is used to configure the transmission direction for the time unit, which may be understood that the transmission direction of the entire frequency domain of the time unit is the transmission direction of the time unit configured by the second configuration information.

For any one time unit on the first time domain resource, the transmission direction of the first frequency domain part may be different from the transmission direction configured by the second configuration information.

For a time unit including the first frequency domain part, the transmission direction of the first frequency domain part is the same as or different from the transmission direction of the time unit configured by the second configuration information.

If the transmission direction of the first frequency domain part is uplink, for a time unit including the first frequency domain part, the transmission direction of the time unit may be configured to be uplink, downlink, or flexible by the second configuration information.

If the transmission direction of the first frequency domain part is downlink, for a time unit including the first frequency domain part, the transmission direction of the time unit may be configured to be uplink, downlink, or flexible by the second configuration information.

In an example, for a time unit including the first frequency domain part, the transmission direction of the first frequency domain part is uplink, and the transmission direction of the time unit configured by the second configuration information is downlink. In one example, for a time unit including the first frequency domain part, the transmission direction of the first frequency domain part is downlink, and the transmission direction of the time unit configured by the second configuration information is flexible. In an example, for a time unit including the first frequency domain part, the transmission direction of the first frequency domain part is downlink, and the transmission direction of the time unit configured by the second configuration information is uplink.

In some embodiments, the second configuration information includes at least one of: TDD-UL-DL-ConfigCommon, TDD-UL-DL-ConfigDedicated, or SFI.

The TDD-UL-DL-ConfigCommon and TDD-UL-DL-ConfigDedicated are used to semi-statically configure the transmission directions of the time units in one period, and the SFI is used to dynamically configure the time units in one period, for which the transmission direction is configured to be flexible by the TDD-UL-DL-ConfigCommon and TDD-UL-DL-ConfigDedicated.

The transmission direction of a time unit may be configured only semi-statically, or may be configured dynamically on the basis of being configured semi-statically.

Taking the transmission direction of a time unit being configured only semi-statically as an example, the transmission direction of a time unit may be configured to be uplink through an Information Element (IE), such as TDD-UL-DL-ConfigCommon, in higher layer signaling (such as Radio Resource Control (RRC) signaling), or the transmission direction of a time unit may be configured to be downlink through TDD-UL-DL-ConfigDedicated.

Taking the transmission direction of a time unit being configured dynamically on the basis of being configured semi-statically as an example, for a time unit for which the transmission direction is configured to be uplink by the second configuration information, the transmission direction of the time unit may be semi-statically configured to be uplink through TDD-UL-DL-ConfigCommon or TDD-UL-DL-ConfigDedicated, or may be dynamically configured to be uplink according to SFI in a case that the transmission direction is semi-statically configured to be flexible through TDD-UL-DL-ConfigCommon or TDD-UL-DL-ConfigDedicated.

In the embodiments of the present disclosure, the time unit includes a time unit in a time domain such as a second, a frame, a subframe, a slot, a sub-slot, or a symbol.

In the embodiments of the present disclosure, the network device may transmit the first configuration information and the second configuration information respectively at different moments. It may be understood that the terminal device may receive the first configuration information and the second configuration information respectively at different moments.

In some embodiments, the network device firstly transmits the first configuration information, and then transmits the second configuration information to the terminal device after transmitting the first configuration information for a certain period of time. In this case, the terminal device firstly receives the first configuration information, and then receives the second configuration information transmitted by the network device after a certain period of time. In some embodiments, the network device firstly transmits the second configuration information, and then transmits the first configuration information to the terminal device after transmitting the second configuration information for a certain period of time. In this case, the terminal device firstly receives the second configuration information, and then receives the first configuration information transmitted by the network device after a certain period of time.

In some embodiments, the first configuration information is used to indicate at least one of:
the first indication content: whether each time unit within the first period belonging to the first time domain resource;
the second indication content: the first number, where the first time domain resource includes the first number of time units in the first period; or
the third indication content: the first position and the first number, where the first time domain resource includes the first number of time units in the first period that use the first position as a starting position or an ending position.

The first time domain resource includes time units within the first period, each of which includes, in frequency domain, the first frequency domain part. The first configuration information indicating the first time domain resource may be understood as indicating a time unit(s) included in the first frequency domain resource.

For the first indication content, the first configuration information indicates whether each of time units within the first period belongs to the first time domain resource.

In some embodiments, whether each of time units within the first period belongs to the first time domain resource may be indicated in a manner of bitmap.

For a time unit in the first period, whether the time unit belongs to the first time domain resource is determined based on a value of a bit corresponding to the time unit. In an example, a value 1 of a bit is 1, indicating that the time unit identified by the bit belongs to the first time domain resource, and a value of a bit is 0, indicating that the time unit identified by the bit does not belong to the first time domain resource.

Taking the value 1 indicating that the time unit belongs to the first time domain resource and the value 0 indicating that the time unit does not belong to the first time domain resource for example, in an example, the first period includes 10 slots, and the first configuration information includes 0011111100. As a result, the second to eighth slots among the 10 slots belong to the first time domain resource.

For the second indication content, the first number is the number of time units included in the first period in the first time domain resource.

For the second indication content, after determining the first number based on the first configuration information, the terminal device determines the first time domain resource based on a preset position and the first number.

If the first frequency domain part is used for uplink transmission, the first number of time units ends at a preset position. It may be understood that the preset position is the last time unit included in the first frequency domain resource. In some embodiments, the preset position includes a previous time unit of the first time unit configured to be uplink by the second configuration information within the first period, or a last time unit within the first period.

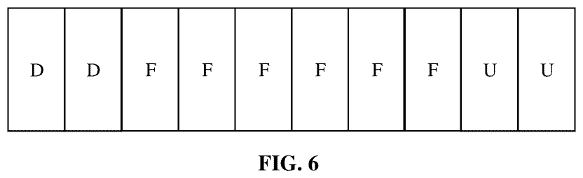

Taking the preset position being a previous time unit of the first time unit configured to be uplink (i.e., uplink time unit) by the second configuration information within the first period as an example, the first period includes 10 slots, and the transmission directions of the 10 slots configured by the second configuration information are illustrated in FIG. 6. The transmission directions of the first and second slots are downlink (identified as D), the transmission directions of the third to eighth slots are flexible (identified as F), and the transmission directions of the ninth to tenth slots are uplink (identified as U). In this case, the last slot including the uplink part is the eighth slot. When the first number indicated by the first configuration information is 5, the fourth to eighth slots include the uplink parts.

Taking the preset position being the last time unit within the first period as an example, the first period includes 10 slots, and the transmission directions of the 10 slots configured by the second configuration information are illustrated in FIG. 6. The transmission directions of the first and second slots are downlink (identified as D), the transmission directions of the third to eighth slots are flexible (identified as F), and the transmission directions of the ninth to tenth slots are uplink (identified as U). In this case, the last slot including the uplink part is the tenth slot. When the first number indicated by the first configuration information is 5, the sixth to tenth slots include the uplink parts.

If the first frequency domain part is used for downlink transmission, the first number of time units starts from a preset position. It may be understood that the time unit at the preset position is the first time unit included in the first frequency domain resource.

In an example, the preset position includes the first time unit within the first period or a next time unit after the last time unit configured to be downlink by the second configuration information.

Taking the preset position being the first time unit within the first period as an example, the first period includes 10 slots, and the transmission directions of the 10 slots configured by the second configuration information are illustrated in FIG. 6. In this case, the first slot including the downlink part is the first slot. When the first number indicated by the first configuration information is 5, the first to fifth slots include the downlink parts.

Taking the preset position being a next time unit after the last time unit configured to be downlink by the second configuration information in the first period as an example, the first period includes 10 slots, and the transmission directions of the 10 slots configured by the second configuration information are illustrated in FIG. 6. In this case, the first slot including the downlink part is the third slot. When the first number indicated by the first configuration information is 5, the third to seventh slots include the downlink parts.

For the third indication content, the first configuration information indicates the first position in addition to the first number, and the first position and the first number are used to determine the first time domain resource. In some embodiments, the first position may be a position of the first or last time unit in the first time domain resource.

The first position is a starting position or an ending position of the first time domain resource in the first period. The first position being the starting position of the first time domain resource may be understood to be that the first position indicates the first time unit of the first time domain resource in the first period. The first position being the ending position of the first time domain resource may be understood to be that the first position indicates the last time unit of the first time domain resource in the first period.

Taking the first position being the starting position of the first time domain resource as an example, the first period includes 10 slots. When the first position indicated by the first configuration information is 2, and the first number indicated by the first configuration information is 5, the second to sixth slots include the first frequency domain parts.

Taking the first position being the ending position of the first time domain resource as an example, the first period includes 10 slots. When the first position indicated by the first configuration information is 8, and the first number indicated by the first configuration information is 5, the fourth to eighth slots include the first frequency domain parts.

In the embodiments of the present disclosure, the content indicated by the first configuration information may include, but is not limited to, the above indication contents.

In some embodiments, the first period is configured by a network device.

In some embodiments, the first period is indicated by the first configuration information.

In some embodiments, the first period is determined based on the second configuration information.

In some embodiments, the first period is determined based on a period configured by the second configuration information. The first period coincides with the period configured by the second configuration information.

The manner for determining the first period includes at least one of the following.

If one period is configured by the second configuration information, the first period is the period configured by the second configuration information.

If at least two periods are configured by the second configuration information, the first period is determined based on the at least two periods configured by the second configuration information. In some embodiments, the first period is a sum of the at least two periods configured by the second configuration information.

In an example, one period P is configured by the second configuration information, then the first period is P. In an example, two periods P1 and P2 are configured by the second configuration information, then the first period is the sum of P1 and P2.

In the embodiments of the present disclosure, the first period may be indicated based on other information in the second configuration information, which may be set by the user according to actual needs and not be limited here.

In some embodiments, a transmission mode of a target time unit belonging to the first time domain resource includes one of the following:
entire frequency domain resource of the target time unit being used for uplink transmission as a whole;
entire frequency domain resource of the target time unit being used for downlink transmission as a whole; and
a transmission mode of the first frequency domain part of the target time unit being independent of a transmission mode of the second frequency domain part of the target time unit. The second frequency domain part is a frequency domain part of the target time unit other than the first frequency domain part.

Here, the target time unit is any one time unit in the first time domain resource. The transmission mode of the target time unit may be understood as at least one of the following:
a transmission direction of the target time unit;
whether the frequency domain resource of the target time unit being scheduled for transmission; or
when the target time unit is scheduled for transmission, resource configuration information for determining a transmission resource for transmission in the target time unit, i.e., a transmission configuration. The resource configuration information includes at least one of: position information for determining a position of a frequency domain transmission resource, a Modulation and Coding Scheme (MCS), and the like.

In some embodiments, the target time unit may be dynamically scheduled for uplink transmission or downlink transmission by higher layer signaling, such as RRC signaling.

Taking the entire frequency domain of the target time unit as a whole as an example, when the entire frequency domain of the target time unit is used for uplink transmission or downlink transmission, and the first frequency domain part and the second frequency domain part have at least one of the following features.

There is only one transmission direction for the whole frequency domain of the target time unit, that is, the transmission directions of the first frequency domain part and the second frequency domain part are the same.

The entire frequency domain of the target time unit is scheduled as a whole.

One piece of resource configuration information is used by the target time unit as a whole to determine the transmission resource.

If the entire frequency domain resource of the target time unit is used for uplink transmission as a whole, the transmission direction of the target time unit is uplink and includes only uplink, the entire frequency domain resource of the target time unit is scheduled as a whole, and one piece of uplink resource configuration information is used to determine the uplink transmission resource for uplink transmission. In this case, the uplink transmission may be scheduled on the entire BWP bandwidth of the target time unit.

If the entire frequency domain resource of the target time unit is used for downlink transmission as a whole, the transmission direction of the target time unit is downlink and includes only downlink, the entire frequency domain resource of the target time unit is scheduled as a whole, and one piece of downlink resource configuration information is used to determine the transmission resource for downlink transmission. In this case, the downlink transmission may be scheduled on the entire BWP bandwidth of the target time unit.

Taking the transmission mode of the first frequency domain part of the target time unit being independent of the transmission mode of the second frequency domain part of the target time unit as an example, the target time unit is used for uplink transmission or downlink transmission, the uplink transmission and the downlink transmission do not overlap in the frequency domain, and the first frequency domain part and the second frequency domain part have at least one of the following features.

The transmission direction of the first frequency domain part is independent of the transmission direction of the second frequency domain part.

The scheduling of the first frequency domain part is independent of the scheduling of the second frequency domain part.

The first frequency domain configuration information is used to determine a transmission resource for transmission in the first frequency domain part, the second frequency domain configuration information is used to determine a transmission resource for transmission in the second frequency domain part, and the first frequency domain configuration information is independent of the second frequency domain configuration information.

If the transmission mode of the first frequency domain part is independent of the transmission mode of the second frequency domain part, the transmission direction of the first frequency domain part and the transmission direction of the second frequency domain part may be the same or different.

If the transmission mode of the first frequency domain part is independent of the transmission mode of the second frequency domain part, the transmission direction of the second frequency domain part includes one of the following: uplink, downlink, or a flexible transmission direction.

Taking the transmission mode of the first frequency domain part being independent of the transmission mode of the second frequency domain part for example, in an example, when the first frequency domain part of the target time unit is used for uplink transmission, and the transmission direction of the second frequency domain part is uplink, the first frequency domain part and the second frequency domain part are both used for uplink transmission, and the first frequency domain part and the second frequency domain part are independently scheduled.

Taking the transmission mode of the first frequency domain part being independent of the transmission mode of the second frequency domain part for example, in an example, when the first frequency domain part of the target time unit is used for uplink transmission, and the transmission direction of the second frequency domain part is downlink or flexible, the first frequency domain part and the second frequency domain part are independently scheduled, and the downlink transmission is performed only in the first frequency domain part.

Taking the transmission mode of the first frequency domain part being independent of the transmission mode of the second frequency domain part for example, in an example, when the first frequency domain part of the target time unit is used for downlink transmission, and the transmission direction of the second frequency domain part is uplink or flexible, the first frequency domain part and the second frequency domain part are independently scheduled, and the uplink transmission is performed only in the first frequency domain part.

In the embodiments of the present disclosure, the solution for determining the transmission mode of the target time unit includes at least one of the following first, second and third solutions.

The first solution is that the transmission mode of the target time unit is determined based on the first configuration information.

The second solution is that the transmission mode of the target time unit is determined based on the first configuration information and the second configuration information.

The third solution is that the transmission direction configured by the second configuration information is limited.

In the embodiment of the present disclosure, when the transmission direction of the target transmission unit is simultaneously configured by the first configuration information and the second configuration information, there is a case where the transmission direction configured by the first configuration information conflicts with the transmission direction configured by the second configuration information. Through any one of the above first to third solutions, the problem that for a time unit, the transmission direction configured by the first configuration information conflicts with the transmission direction configured by the second configuration information can be solved.

In the first solution, the transmission mode of the target time unit is determined based on the first configuration information.

In some embodiments, the transmission mode of the first frequency domain part of the target time unit is independent of the transmission mode of the second frequency domain part of the target time unit.

Taking the first frequency domain part being used for uplink transmission as an example, the transmission direction of the first frequency domain part of the target time unit is uplink, the uplink transmission on the target time unit is performed in the first frequency domain part, and the downlink transmission on the target time unit is only performed in the second frequency domain part of the target time unit.

Taking the first frequency domain part being used for downlink transmission as an example, the transmission direction of the first frequency domain part of the target time unit is downlink, the downlink transmission on the target time unit is performed in the first frequency domain part, and the uplink transmission on the target time unit is only performed in the second frequency domain part of the target time unit.

In the first solution, the transmission mode of the first frequency domain resource in the target time unit is independent of the transmission mode of the frequency domain resource other than the first frequency domain resource in the target time unit, the transmission direction of the first frequency domain part is independent of the transmission direction of the second frequency domain part, and the scheduling of the first frequency domain part is independent of the scheduling of the second frequency domain part.

In the first solution provided by the embodiment of the present disclosure, the transmission mode of the time unit may be determined only based on the first configuration information. The solution is simple to implement, and can accelerate the efficiency of the terminal in determining the transmission direction or the transmission mode can be accelerated.

In the second solution, the transmission mode of the target time unit is determined based on the first configuration information and the second configuration information.

In some embodiments, the transmission mode of the target time unit is determined by at least one of the following determination modes A1 to A9.

In the determination mode A1, if the first frequency domain part is used for uplink transmission, and a transmission direction of the target time unit is configured to be uplink by the second configuration information, the entire frequency domain resource of the target time unit is used for uplink transmission as a whole.

In the determination mode A2, if the first frequency domain part is used for uplink transmission, and the transmission direction of the target time unit is configured to be downlink by the second configuration information, a transmission mode of the first frequency domain part is independent of the transmission mode of the second frequency domain part, and the second frequency domain part is used for downlink transmission.

In the determination mode A3, if the first frequency domain part is used for uplink transmission, and the transmission direction of the target time unit is configured to be flexible by the second configuration information, the entire frequency domain resource of the target time unit is used for uplink transmission as a whole.

In the determination mode A4, if the first frequency domain part is used for uplink transmission, and the transmission direction of the target time unit is configured to be flexible by the second configuration information, the transmission mode of the first frequency domain part is independent of the transmission mode of the second frequency domain part.

In the determination mode A5, if the first frequency domain part is used for uplink transmission, the transmission direction of the target time unit is configured to be flexible by the second configuration information, and the target time unit is scheduled for uplink transmission, then the entire frequency domain resource of the target time unit is used for uplink transmission as a whole.

In the determination mode A6, if the first frequency domain part is used for uplink transmission, the transmission direction of the target time unit is configured to be flexible by the second configuration information, the target time unit is scheduled for uplink transmission, and the first frequency domain resource is located within the first frequency domain part, then the transmission mode of the first frequency domain part is independent of the transmission mode of the second frequency domain part. The first frequency domain resource is a frequency domain resource of the target time unit in frequency domain that is used for uplink transmission.

In the determination mode A7, if the first frequency domain part is used for uplink transmission, the transmission direction of the target time unit is configured to be flexible by the second configuration information, the target time unit is scheduled for uplink transmission, and the first frequency domain resource occupies the second frequency domain part of the target time unit, then the transmission mode of the first frequency domain part is independent of the transmission mode of the second frequency domain part.

In the determination mode A8, if the first frequency domain part is used for uplink transmission, the transmission direction of the target time unit is configured to be flexible by the second configuration information, the target time unit is scheduled for uplink transmission, and the first frequency domain resource occupies the first frequency domain part and the second frequency domain part of the target time unit, then the entire frequency domain of the target time unit is used for uplink transmission as a whole.

In the determination mode A9, if the first frequency domain part is used for uplink transmission, the transmission direction of the target time unit is configured to be flexible by the second configuration information, and the target time unit is scheduled for downlink transmission, then the transmission mode of the first frequency domain part is independent of the transmission mode of the second frequency domain part, and the second frequency domain part is used for downlink transmission.

The determination modes A1 to A9 are for a scenario in which the first frequency domain part is used for uplink transmission.

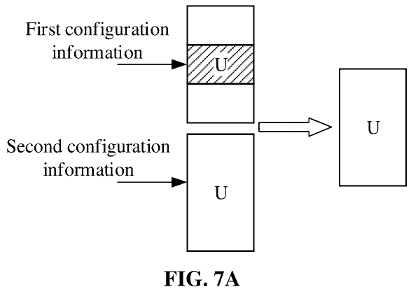

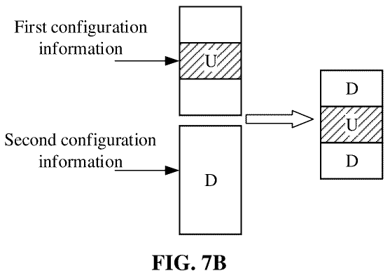

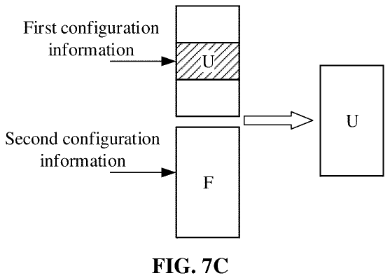

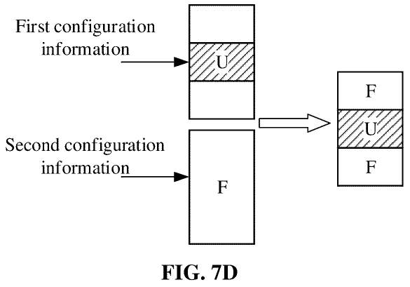

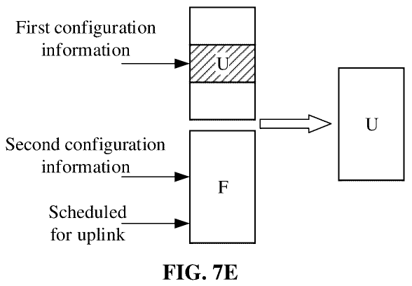

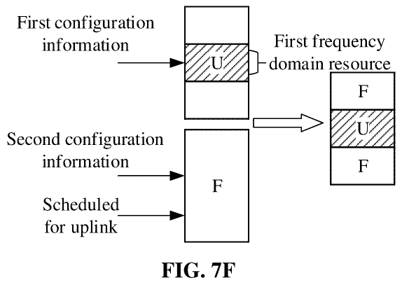

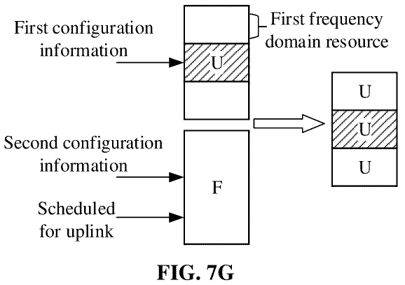

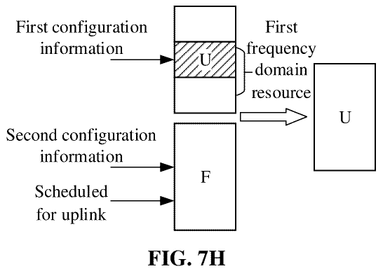

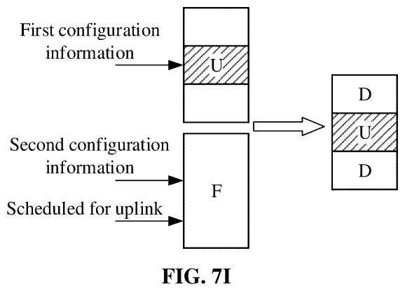

In the determination mode A1, for the target time unit, as illustrated in FIG. 7A, the target time unit is configured to include the first frequency domain part (indicated by a part filled by slashes) whose transmission direction is uplink by the first configuration information, and the transmission direction of the target time unit is configured to be uplink by the second configuration information. Then, the entire frequency domain of the target time unit is used for uplink transmission as a whole.

In the determination mode A2, for the target time unit, as illustrated in FIG. 7B, the target time unit is configured to include the first frequency domain part whose transmission direction is uplink by the first configuration information, and the transmission direction of the target time unit is configured to be downlink by the second configuration information. Then, the transmission mode of the first frequency domain part is independent of the transmission mode of the second frequency domain part, the first frequency domain part is used for uplink transmission and the second frequency domain part is used for downlink transmission. In this case, the target time unit can be used for uplink transmission and downlink transmission, and the uplink transmission and downlink transmission do not overlap in the time domain.

In the determination mode A3, for the target time unit, as illustrated in FIG. 7C, the target time unit is configured to include the first frequency domain part whose transmission direction is uplink by the first configuration information, and the transmission direction of the target time unit configured to be flexible by the second configuration information. Then, the entire frequency domain of the target time unit is used for uplink transmission.

In the determination mode A4, for the target time unit, as illustrated in FIG. 7D, the target time unit is configured to include the first frequency domain part whose transmission direction is uplink by the first configuration information, and the transmission direction of the target time unit is configured to be flexible by the second configuration information. Then, the transmission mode of the first frequency domain part is independent of the transmission mode of the second frequency domain part.

In some embodiments, the transmission direction of the second frequency domain part is flexible.

In the transmission mode determined by the determination mode A4, the downlink transmission is scheduled only in the second frequency domain part.

In the determination mode A5, for the target time unit, as illustrated in FIG. 7E, the target time unit is configured to include the first frequency domain part whose transmission direction is uplink by the first configuration information, and the transmission direction of the target time unit is configured to be flexible by the second configuration information, and the target time unit is scheduled for uplink transmission. Then, the entire frequency domain of the target time unit is used for uplink transmission as a whole.

In the transmission mode determined by the determination mode A5, the entire frequency domain of the target time unit is used as a whole for uplink transmission, regardless of the frequency domain relationship between the scheduled uplink resource and the first frequency domain part.

In the determination mode A6, for the target time unit, as illustrated in FIG. 7F, when the target time unit is configured to include the first frequency domain part whose transmission direction is uplink by the first configuration information, the transmission direction of the target time unit is configured to be flexible by the second configuration information, the target time unit is scheduled for uplink transmission, and the first frequency domain resource is located within the first frequency domain part. Then, the transmission mode of the first frequency domain part is independent of the transmission mode of the second frequency domain part.

In some embodiments, the transmission direction of the second frequency domain part is flexible. In a case that the first frequency domain part is used for uplink transmission and the transmission mode of the first frequency domain part is independent of the transmission mode of the second frequency domain part, the downlink transmission is scheduled only in the second frequency domain part.

In the determination mode A7, the first frequency domain resource occupying the second frequency domain part of the target time unit may be understood to be that the first frequency domain resource occupies only the second frequency domain part and does not occupy the first frequency domain part.

For the target time unit, as illustrated in FIG. 7G, the target time unit is configured to include the first frequency domain part whose transmission direction is uplink by the first configuration information, the transmission direction of the target time unit is configured to be flexible by the second configuration information, the target time unit is scheduled for uplink transmission, and the first frequency domain resource occupies the second frequency domain part of the target time unit. Then, the transmission mode of the first frequency domain part is independent of the transmission mode of the second frequency domain part.

In some embodiments, the second frequency domain part is used for uplink transmission.

In a practical application, in the scenario of the determination mode A7, the target time unit is configured to include the first frequency domain part whose transmission direction is uplink by the first configuration information, the transmission direction of the target time unit configured to be flexible by the second configuration information, the target time unit is scheduled for uplink transmission, and the first frequency domain resource occupies the second frequency domain part of the target time unit. Then, the entire frequency domain of the target time unit may be used for uplink transmission as a whole.

In the determination mode A8, for the target time unit, as illustrated in FIG. 7H, the target time unit is configured to include the first frequency domain part whose transmission direction is uplink by the first configuration information, the transmission direction of the target time unit is configured to be flexible by the second configuration information, the target time unit is used for uplink transmission, and the first frequency domain resource occupies the first frequency domain part and the second frequency domain part of the target time unit. Then, the frequency domain of the target time unit is used for uplink transmission as a whole.

In the determination mode A9, for the target time unit, as illustrated in FIG. 7I, the target time unit is configured to include the first frequency domain part whose transmission direction is uplink by the first configuration information, the transmission direction of the target time unit configured to be flexible by the second configuration information, and the target time unit is scheduled for downlink transmission. Then, the transmission mode of the first frequency domain part is independent of the transmission mode of the second frequency domain part, and the second frequency domain part is used for downlink transmission. In this case, the target time unit can be used for uplink transmission and downlink transmission, and the uplink transmission and downlink transmission do not overlap in the time domain.

It may be understood that the determination modes A1 to A4 are used for determining the transmission mode of the target time unit in a case that the target time unit is not scheduled, and the determination modes A5 to A9 are used for determining the transmission mode of the target time unit in a case that the transmission direction of the target time unit is configured to be flexible and the target time unit is scheduled. The frequency domain relationship between the scheduled uplink resource and the first frequency domain part is not considered in the determination modes A5 and A9, and the frequency domain relationship between the scheduled uplink resource and the first frequency domain part is needed to be considered in the determination modes A6 to A8.

In some embodiments, for the determination modes A1 to A5 and A9, an uplink transmission resource used for uplink transmission in a case that the transmission mode of the first frequency domain part is independent of the transmission mode of the second frequency domain part, and an uplink transmission resource used for uplink transmission in a case that the entire frequency domain of the target time unit as a whole is used for uplink transmission, are determined based on different uplink resource configuration information. In the case that the transmission mode of the first frequency domain part is independent of the transmission mode of the second frequency domain part, the transmission resource used for transmission in the first frequency domain part is determined based on the first uplink resource configuration information. In the case that the entire frequency domain of the target time unit as a whole is used for uplink transmission, the transmission resource used for transmission in the target time unit is determined based on the second uplink resource configuration information.

In some embodiments, the transmission mode of the target time unit is determined by at least one of the following determination modes B1 to B9.

In the determination mode B1, if the first frequency domain part is used for downlink transmission, and the transmission direction of the target time unit is configured to be downlink by the second configuration information, then the entire frequency domain resource of the target time unit is used for downlink transmission as a whole.

In the determination mode B2, if the first frequency domain part is used for downlink transmission, and the transmission direction of the target time unit is configured to be uplink by the second configuration information, then the transmission mode of the first frequency domain part is independent of the transmission mode of the second frequency domain part, and the second frequency domain part is used for uplink transmission.

In the determination mode B3, if the first frequency domain part is used for downlink transmission, and the transmission direction of the target time unit is configured to be flexible by the second configuration information, then the entire frequency domain resource of the target time unit is used for downlink transmission as a whole.

In the determination mode B4, if the first frequency domain part is used for downlink transmission, and the transmission direction of the target time unit is configured to be flexible by the second configuration information, then the transmission mode of the first frequency domain part is independent of the transmission mode of the second frequency domain part.

In the determination mode B5, if the first frequency domain part is used for downlink transmission, the transmission direction of the target time unit is configured to be flexible by the second configuration information, and the target time unit is scheduled for downlink transmission, then the entire frequency domain resource of the target time unit is used for downlink transmission as a whole.

In the determination mode B6, if the first frequency domain part is used for downlink transmission, the transmission direction of the target time unit is configured to be flexible by the second configuration information, the target time unit is scheduled for downlink transmission, and the second frequency domain resource is located within the first frequency domain part, then the transmission mode of the first frequency domain part is independent of the transmission mode of the second frequency domain part. The second frequency domain resource is a frequency domain resource of the target time unit in the frequency domain that is used for downlink transmission.

In the determination mode B7, if the first frequency domain part is used for downlink transmission, the transmission direction of the target time unit is configured to be flexible by the second configuration information, the target time unit is scheduled for downlink transmission, and the second frequency domain resource occupies the second frequency domain part, then the transmission mode of the first frequency domain part is independent of the transmission mode of the second frequency domain part.

In the determination mode B8, if the first frequency domain part is used for downlink transmission, the transmission direction of the target time unit is configured to be flexible by the second configuration information, the target time unit is scheduled for downlink transmission, and the second frequency domain resource occupies the first frequency domain part and the second frequency domain part, then the entire frequency domain resource of the target time unit is used for downlink transmission as a whole.

In the determination mode B9, if the first frequency domain part is used for downlink transmission, the transmission direction of the target time unit is configured to be flexible by the second configuration information, and the target time unit is scheduled for uplink transmission, then the transmission mode of the first frequency domain part is independent of the transmission mode of the second frequency domain part, and the second frequency domain part is used for uplink transmission.

In a practical application, in the scenario of the determination mode B7, the target time unit is configured to include the first frequency domain part whose transmission direction is downlink by the first configuration information, the transmission direction of the target time unit is configured to be flexible by the second configuration information, the target time unit is scheduled for downlink transmission, and the second frequency domain resource occupies the second frequency domain part of the target time unit. In this case, the entire frequency domain of the target time unit may be used for downlink transmission as a whole.

In the determination modes B2, B4, B6, B7, and B9, the transmission mode of the first frequency domain part is independent of the transmission mode of the second frequency domain part. The transmission direction of the second frequency domain part is uplink in the determination modes B2 and B9, the transmission direction of the second frequency domain part is flexible in the determination modes B4 and B6, and the transmission direction of the second frequency domain part is downlink in the determination mode B7.

In some embodiments, for the determination modes B1 to B5 and B9, a downlink transmission resource used for downlink transmission in a case that the transmission mode of the first frequency domain part is independent of the transmission mode of the second frequency domain part, and a downlink transmission resource in a case that the entire frequency domain of the target time unit as a whole is used for downlink transmission, are determined based on different downlink frequency domain resource configuration information. In the case that the transmission mode of the first frequency domain part is independent of the transmission mode of the second frequency domain part, the downlink resource in the first frequency domain part is determined based on the first downlink resource configuration information. In the case that the entire frequency domain of the target time unit as a whole is used for downlink transmission, the downlink resource in the target time unit is determined based on the second downlink resource configuration information.

In some embodiments, the target time unit is scheduled for uplink transmission in the determination modes A5 to A8 and B9. The uplink transmission may include a Physical Uplink Shared Channel (PUSCH) transmission or a Physical Uplink Control Channel (PUCCH) transmission. If the target time unit is scheduled for the PUSCH transmission, the first frequency domain resource is a PUSCH frequency domain resource. If the target time unit is scheduled for the PUCCH transmission, the first frequency domain resource is a PUCCH frequency domain resource.

In some embodiments, the target time unit is scheduled for downlink transmission in the determination modes A9 and B5 to B8. The downlink transmission may include a Physical Downlink Shared Channel (PDSCH) transmission or a Physical Downlink Control Channel (PDCCH) transmission. If the target time unit is scheduled for the PDSCH transmission, the second frequency domain resource is a PDSCH frequency domain resource. If the target time unit is scheduled for the PDCCH transmission, the second frequency domain resource is a PDCCH frequency domain resource.

In the third solution, if the first frequency domain part is used for uplink transmission, a transmission direction of a time unit in the first time domain resource is configured to be downlink by the second configuration information. Optionally, if the first frequency domain part is used for downlink transmission, a transmission direction of a time unit in the first time domain resource is configured to be uplink by the second configuration information.

If the first frequency domain part is used for uplink transmission, it is limited that the transmission direction of the time unit in the first time domain resource is configured to be downlink by the second configuration information. In this case, the first frequency domain part of the target time unit is used for uplink transmission, and the second frequency domain part is used for downlink transmission. The limiting that the transmission direction of the time unit in the first time domain resource is configured to be downlink by the second configuration information may be understood to be that the transmission direction of the time unit in the first time domain resource is configured to be only downlink by the second configuration information.

If the first frequency domain part is used for downlink transmission, it is limited that the transmission direction of the time unit in the first time domain resource is configured to be uplink by the second configuration information. In this case, the first frequency domain part of the target time unit is used for downlink transmission, and the second frequency domain part is used for uplink transmission. The limiting that the transmission direction of the time unit in the first time domain resource is configured to be uplink by the second configuration information may be understood to be that the transmission direction of the time unit in the first time domain resource is configured to be only uplink by the second configuration information

In the embodiments of the present disclosure, the transmission direction of the time unit including the first frequency domain part configured by the second configuration information is limited based on the transmission direction of the first frequency domain part, thereby avoiding collision between the first configuration information and the second configuration information while realizing simultaneous uplink transmission and downlink transmission in one time unit.

Hereinafter, the wireless communication method provided by the embodiment of the present disclosure will be further described.

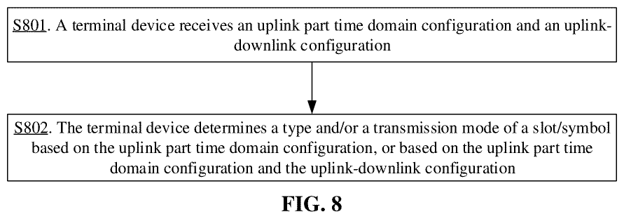

As illustrated in FIG. 8, a wireless communication method provided by an embodiment of the present disclosure includes the following operations: S801, S802.

In operation S801, a terminal device receives an uplink part time domain configuration and an uplink-downlink configuration.

The uplink part time domain configuration is the first configuration information of which the indicated frequency domain resource is a frequency domain position of an uplink part. The uplink part time domain configuration is used for indicating a slot/symbol occupied by an SBFD slot/symbol including an uplink part (i.e., an uplink subband), in one transmission period, and a frequency domain position occupied by the uplink part in the SBFD slot/symbol.

The uplink-downlink configuration is the second configuration information, and is used for indicating the transmission directions of respective slots/symbols in one transmission period. The uplink-downlink configuration may include one or more of a TDD-UL-DL-ConfigCommon and TDD-UL-DL-ConfigDedicated.

In operation S802, the terminal device determines a type and/or a transmission mode of the slot/symbol based on the uplink part time domain configuration, or based on the uplink part time domain configuration and the uplink-downlink configuration.

Here, for a slot/symbol that is semi-statically configured to be flexible and is indicated to include an uplink part, the slot/symbol is a slot/symbol including an uplink part, or an uplink slot/symbol, or a slot/symbol determined to include an uplink part according to scheduling, or an uplink slot/symbol determined according to scheduling, a slot/symbol determined to include an uplink part according to an SFI indication, or an uplink slot/symbol determined according to an SFI indication. Each of slots/symbols is transmitted in a respective transmission mode.

Hereinafter, the wireless communication method provided by the embodiment of the present disclosure will be described with reference to different examples: first example and second example.

In the first example, the transmission mode is determined based on the uplink part time domain configuration.

In operation S11, the terminal receives the uplink part time domain configuration and the uplink-downlink configuration.

Here, the uplink part time domain configuration is used to indicate an uplink part and a slot/symbol including the uplink part (indicating SBFD).

The uplink part time domain configuration indicates a slot/symbol including the uplink part.

The uplink part time domain configuration indicates the slot/symbol including the uplink part by at least one of the following modes: first mode, second mode and third mode.

In the first mode, whether each slot/symbol in a period is a slot/symbol including the uplink part is indicated in a manner of bitmap.

For example, the value 1 indicates that the slot/symbol includes the uplink part, and the value 0 indicates that the slot/symbol does not include the uplink part.

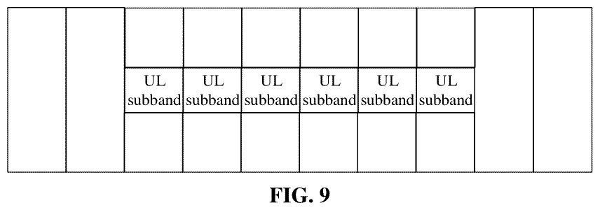

As illustrated in FIG. 9, 10 bits [0 0 1 1 1 1 1 1 0 0] are adopted to indicate an uplink part time domain configuration of 10 slots included in one period of 10 ms. The [0 0 1 1 1 1 1 1 0 0] indicates that the third to eighth slots, i.e., slots 3 to 8, include the uplink part.

In the second mode, the number of slots/symbols including the uplink part in one period is indicated in a counting manner.

Further, the slot/symbol including the uplink part ends at the uplink slot/symbol. As illustrated in FIG. 9, when the number of slots including the uplink part is indicated to be 6, 6 slots are counted forward from the previous slot of the first uplink slot, i.e., the eighth slot, that is, the third to eighth slots include the uplink part.

In the third mode, the starting slot/symbol and the number of slots/symbols in one period are indicated in a manner of resource indication value (RIV).

In one example, when the RIV is 52, the starting slot is the third slot and the number of slots is 6, that is, the third to eight slots are slots including the uplink part.

The period is configured by the network device.

In some embodiments, the period of the uplink part time domain configuration coincides with the period of the uplink-downlink configuration. For example, if only pattern 1 is configured in the uplink-downlink configuration and pattern 1 is dl-UL-TransmissionPeriodicity P, the period of the uplink part time domain configuration is dl-UL-TransmissionPeriodicity P. If pattern 1 and pattern 2 are configured in the uplink-downlink configuration, and pattern 1 is dl-UL-TransmissionPeriodicity P and pattern 2 is dl-UL-TransmissionPeriodicity P2, the period of the uplink part time domain configuration is dl-UL-TransmissionPeriodicity P+dl-UL-TransmissionPeriodicity P2.

In operation S12, the terminal determines the type and/or the transmission mode of the slot/symbol based on the uplink part time domain configuration.

According to the configurations received in the operation S11, the terminal knows that the slots 3 to 8 include the uplink part. Regardless of whether the slots 3 to 8 are downlink slots, flexible slots, or even uplink slots (except for the counting method), as illustrated in FIG. 9, information is transmitted and received in the slots 3 to 8 according to the configuration including the uplink part.

For example, for the slot/symbol including the uplink part, the uplink transmission is limited to the uplink part. For another example, the downlink transmission can only be performed in frequency domains other than the uplink part. For another example, the network configures for the terminal two PUCCH configurations (PUCCH-Config): PUCCH-Config 1 and PUCCH-Config 2, where the PUCCH-Config 1 is used for the uplink part, and the PUCCH-Config 2 is used for the uplink slot/flexible slot. For slots 3 to 8, PUCCH resources are determined according to the PUCCH-Config 1, and for slots 9 to 10, PUCCH resources are determined according to the PUCCH-Config 2.

In the second example, the transmission mode is determined based on the uplink part time domain configuration and the uplink-downlink configuration.

In operation S21, the terminal receives the uplink part time domain configuration and the uplink-downlink configuration.

Here, the uplink part time domain configuration is used for indicating an uplink part and a slot/symbol including the uplink part (indicating SBFD).

The uplink part time domain configuration indicates a slot/symbol including the uplink part.

The uplink part time domain configuration indicates the slot/symbol including the uplink part by at least one of the following modes: first mode, second mode and third mode.

In the first mode, whether each slot/symbol in one period is a slot/symbol including the uplink part is indicated in a manner of bitmap.

For example, the value 1 indicates that the slot/symbol includes the uplink part, and the value 0 indicates that the slot/symbol does not include the uplink part.

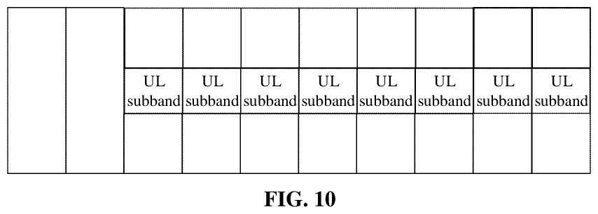

As illustrated in FIG. 10, 10 bits [0 0 1 1 1 1 1 1 1 1 1] are adopted to indicate an uplink part time domain configuration of 10 slots included in one period of 10 ms. The [0 0 1 1 1 1 11 1 1 1 1 1] indicates that the third to tenth slots include the uplink part.

In the second mode, the number of slots/symbols including the uplink part in one period is indicated in a counting manner.

Further, the slot/symbol including the uplink part ends at the last slot/symbol. As illustrated in FIG. 10, when the number of slots including the uplink part is indicated to be 8, 8 slots are counted forward from the last slot, i.e., the tenth slot. That is, the slots 3 to 10 include the uplink part.

In the third mode, the starting slot/symbol and the number of slots/symbols in one period are indicated in a manner of RIV.

In one example, when the RIV is 72, the starting slot is the third slot and the number of slots is 8. That is, slots 3 to 10 include the uplink part.

The period is configured by the network device.

In some embodiments, the period of the uplink part time domain configuration coincides with the period of the uplink-downlink configuration. For example, if only pattern 1 is configured in the uplink-downlink configuration and pattern 1 is dl-UL-TransmissionPeriodicity P, the period of the uplink part time domain configuration is dl-UL-TransmissionPeriodicity P. If pattern 1 and pattern 2 are configured in the uplink-downlink configuration and pattern 1 is dl-UL-TransmissionPeriodicity P and pattern 2 is dl-UL-TransmissionPeriodicity P2, the period of the uplink part time domain configuration is dl-UL-TransmissionPeriodicity P+dl-UL-TransmissionPeriodicity P2.

The uplink-downlink configuration may be indicated by TDD-UL-DL-ConfigCommon, or by TDD-UL-DL-ConfigCommon and TDD-UL-DL-ConfigDedicated.

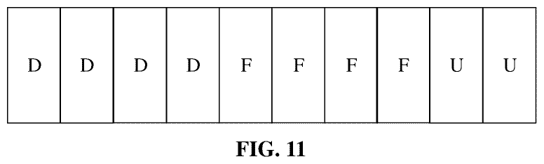

As illustrated in FIG. 11, the uplink-downlink configuration is nrofDownlinkSlots=4, representing that four slots (slots 1 to 4) counted backward from the first slot are downlink slots; nrofDownlinkSymbols=0, representing that the downlink symbol is not included in the fifth slot, nrofUplinkSlots=2, representing that two slots (slots 9 and 10) counted forward from the last slot are uplink slots; nrofUplinkSymbols=0, representing that the uplink symbol is not included in the eighth slot. As illustrated in FIG. 11, slots 5 to 8 are flexible slots (F).

In operation S22, the terminal determines the type and/or the transmission mode of the slot/symbol based on the uplink part time domain configuration and the uplink-downlink configuration.

In the first scenario, if a slot/symbol is indicated to include an uplink part based on the uplink part time domain configuration and is also indicated to be a downlink slot/symbol based on the uplink-downlink configuration, the slot/symbol is a slot/symbol including the uplink part (or an SBFD slot/symbol).

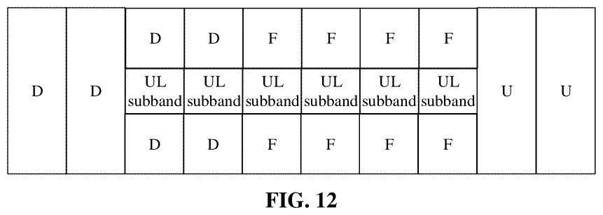

For slots 3 and 4 illustrated in FIG. 10 to FIG. 12, slots 3 and 4 include the uplink part as illustrated in FIG. 10, slots 3 and 4 are indicated to be downlink slots as illustrated in FIG. 11, and slots 3 and 4 are slots including the uplink part as illustrated in FIG. 12.

In some embodiments, information transmission on the slot/symbol is processed according to a configuration corresponding to the SBFD slot/symbol.

For example, for the slot including the uplink part, the uplink transmission is limited to the uplink part. For another example, the downlink transmission can only be performed in frequency domains other than the uplink part. For another example, the network configures for the terminal two PUCCH-Configs: PUCCH-Config 1 and PUCCH-Config 2, where the PUCCH-Config 1 is used for the uplink part, and the PUCCH-Config 2 is used for the uplink slot. For slots 3 to 4, PUCCH resources are determined according to the PUCCH-Config 1.

In the second scenario, if a slot/symbol is indicated to include an uplink part based on the uplink part time domain configuration and is also indicated to be an uplink slot/symbol based on the uplink-downlink configuration, the slot/symbol is an uplink slot/symbol.

For slots 9 and 10 as illustrated in FIG. 10 to FIG. 12, the slots 9 and 10 include an uplink part as illustrated in FIG. 10, the slots 9 and 10 are indicated to be uplink slots as illustrated in FIG. 11, and the slots 9 and 10 are uplink slots as illustrated in FIG. 12.

The information transmission on the slot/symbol is processed according to the configuration corresponding to the uplink slot/symbol. For example, the uplink transmission may be scheduled on the entire BWP bandwidth. For another example, the network configures for the terminal two PUCCH-Configs: PUCCH-Config 1 and PUCCH-Config 2, where PUCCH-Config 1 is used for the uplink part, and PUCCH-Config 2 is used for the uplink slot. For the slots 9 to 10, the PUCCH resource is determined according to the PUCCH-Config 2.

In the third scenario, if a slot/symbol is indicated to include an uplink part based on the uplink part time domain configuration and is also indicated to be a flexible slot/symbol based on the uplink-downlink configuration, the slot/symbol is one of the following cases A1, A2, A3.

In the case A1, the slot/symbol is an uplink slot/symbol.

The information transmission on the slot/symbol is processed according to the configuration corresponding to the uplink slot/symbol. For example, the uplink transmission may be scheduled on the entire BWP bandwidth. For another example, the network configures for the terminal two PUCCH-Configs: PUCCH-Config 1 and PUCCH-Config2, where the PUCCH-Config 1 is used for the uplink part and the PUCCH-Config 2 is used for the uplink slot. For the slot, the PUCCH resource is determined according to the PUCCH-Config 2.

The use of uplink resources can be maximized in the case A1.

In the case A2, the slot/symbol is a slot/symbol including an uplink part (or SBFD slot/symbol).

The information transmission on the slot/symbol is processed according to the configuration corresponding to the SBFD slot/symbol. For example, for the slot/symbol including the uplink part, the uplink transmission is limited to the uplink part. For another example, the downlink transmission can only be performed in frequency domains other than the uplink part. For another example, the network configures for the terminal two PUCCH-Configs: PUCCH-Config 1 and PUCCH-Config2, where the PUCCH-Config 1 is used for the uplink part and the PUCCH-Config 2 is used for the uplink slot. For the slot, the PUCCH resource is determined according to the PUCCH-Config 1.

As illustrated in FIG. 10 to FIG. 12, slots 5 to 8 are indicated to include the uplink part and are also indicated to be flexible slots (F). Then, the slots 5 to 8 are slots including the uplink part.

In the case A2, the use of downlink resources can be maximized, and unnecessary interference caused by receiving information in the uplink part can be avoided.

In the case A3, the slot/symbol is determined to be an uplink slot/symbol or a slot/symbol including an uplink part according to a scheduling situation thereof.

In a method 3.1A, the slot/symbol is determined to be an uplink slot/symbol or a slot/symbol including an uplink part according to the scheduling situation thereof and a frequency domain relationship between the uplink resource and the uplink part.

In a method 3.1.1A, if the slot/symbol is scheduled for PDSCH, the slot/symbol is a slot/symbol including an uplink part, and downlink data is received only in an area other than the uplink part in the slot/symbol.

In a method 3.1.2A, if the slot/symbol is scheduled for PUSCH or PUCCH, and the PUSCH resource or PUCCH resource is allocated to the frequency domain resource other than the uplink part, the slot/symbol is an uplink slot/symbol, and the uplink transmission may be scheduled on the entire BWP bandwidth.

In a method 3.1.3A, if the slot/symbol is scheduled for PUSCH or PUCCH, and the PUSCH resource or PUCCH resource is allocated to the frequency domain resource only on the uplink part, the slot/symbol is a slot/symbol including the uplink part, and the uplink transmission is only scheduled on the uplink part.

It should be noted that the PUSCH resource and the PUCCH resource in the methods 3.1.2A and 3.1.3A are not distinguished between the configuration used for the uplink part and the configuration used for the uplink slot/symbol. There is only one PUSCH configuration or PUCCH configuration. The PUSCH resource or PUCCH resource is determined based on the PUSCH configuration or the PUCCH configuration. In a case that the symbol/slot is scheduled to PUSCH or PUCCH, it is determined whether the symbol/slot is an uplink slot/symbol or a slot/symbol including the uplink part based on the frequency domain relationship between the PUSCH resource or the PUCCH resource and the uplink part.

In a method 3.2A, the slot/symbol is determined to be an uplink symbol or a symbol including an uplink part according to a scheduling situation.

In a method 3.2.1A, if the slot/symbol is scheduled for PDSCH, the slot/symbol is a slot/symbol including an uplink part, and downlink data is received only in an area other than the uplink part of the slot/symbol.

In a method 3.2.2A, if the slot/symbol is scheduled for PUSCH or PUCCH, the slot/symbol is an uplink slot/symbol.

The uplink transmissions may be scheduled on the entire BWP bandwidth.

For another example, the network configures for the terminal two PUCCH-Configs, where the PUCCH-Config 1 is used for the uplink part, and the PUCCH-Config 2 is used for the uplink slot. For the slot/symbol, the PUCCH resource is determined according to the PUCCH-Config 2.

In the third example, the transmission mode is determined based on the uplink part time domain configuration and the dynamic uplink-downlink configuration

In operation S31, the terminal receives the uplink part time domain configuration and the uplink-downlink configuration.

The uplink part time domain configuration is used to indicate a frequency domain resource and a time domain resource in which the frequency domain resource is located. The frequency domain resource enables the time domain resource to be used for uplink transmission and downlink transmission. The frequency domain resource can allow that uplink transmission and downlink transmission of the time domain resource do not overlap in the time domain.

Here, the uplink part time domain configuration is used to indicate the uplink part and a slot or symbol including the uplink part (indicating SBFD).

The uplink part time domain configuration indicates a slot/symbol including the uplink part.

The uplink part time domain configuration indicates the slot/symbol including the uplink part by at least one of the following modes: first mode, second mode, third mode.

In the first mode, whether each slot/symbol in one period is a slot/symbol including the uplink part is indicated in a manner of bitmap.

For example, the value 1 indicates that the slot/symbol includes the uplink part, and the value 0 indicates that the slot/symbol does not include the uplink part.

As illustrated in FIG. 10, 10 bits [0 0 1 1 1 1 1 1 1 1 1] are adopted to indicate an uplink part time domain configuration of 10 slots included in one period of 10 ms. The [0 0 1 1 1 1 1 1 1 1 1 1 1] indicates that the third to tenth slots include the uplink part.

In the second mode, the number of slots/symbols including the uplink part in one period is indicated in a counting manner.

Further, the slot/symbol including the uplink part ends at the last slot/symbol. As illustrated in FIG. 10, when the number of slots including the uplink part is indicated to be 8, 8 slots are counted forward from the last slot, i.e., the tenth slot. That is, the slots 3 to 10 include the uplink part.

In the third mode, the starting slot/symbol and the number of slots/symbols in one period are indicated in a manner of RIV.

In one example, when the RIV is 72, the starting slot is the third slot and the number of slots is 8, that is, slots 3 to 10.

The period is configured by the network device.

In some embodiments, the period of the uplink part time domain configuration coincides with the period of the uplink-downlink configuration. For example, if only pattern 1 is configured in the uplink-downlink configuration and pattern 1 is dl-UL-TransmissionPeriodicity P, the period of the uplink part time domain configuration is dl-UL-TransmissionPeriodicity P. If pattern 1 and pattern 2 are configured in the uplink-downlink configuration, and pattern 1 is dl-UL-TransmissionPeriodicity P and pattern 2 is dl-UL-TransmissionPeriodicity P2, the period of the uplink part time domain configuration is dl-UL-TransmissionPeriodicity P+dl-UL-TransmissionPeriodicity P2.

The uplink-downlink configuration may be indicated by TDD-UL-DL-ConfigCommon, or by TDD-UL-DL-ConfigCommon and TDD-UL-DL-ConfigDedicated. As illustrated in FIG. 11, the uplink-downlink configuration is nrofDownlinkSlots=4, representing that four slots (slots 1 to 4) counted backward from the first slot are downlink slots;

nrofDownlinkSymbols=0, representing that the downlink symbol is not included in the fifth slot, nrofUplinkSlots=2, representing that two slots (slots 9 and 10) counted forward from the last slot are uplink slots; nrofUplinkSymbols=0, representing that the uplink symbol is not included in the eighth slot. As illustrated in FIG. 11, slots 5 to 8 are flexible slots (F).

Further, the flexible slot/symbol is set through the SFI received by the terminal device, and is indicated to be an uplink slot/symbol or a downlink slot/symbol.

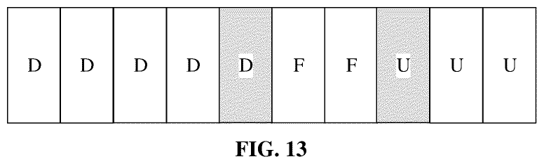

In one example, according to SFI, the fifth slot in the period illustrated in FIG. 11 is indicated to be the downlink slot (D), and the eighth slot is indicated to be the uplink slot (U). Then, the indication result is as illustrated in FIG. 13, where the first to fifth slots are downlink slots, the sixth to seventh slots are flexible slots, and the eighth to tenth slots are uplink slots.

In operation S32, the terminal determines a type and/or a transmission mode of a slot/symbol based on the uplink part time domain configuration.

For the transmission modes of the first to fourth, sixth to seventh, and ninth to tenth slots in FIG. 13, the reference may be made to the method for determining the transmission mode of the slot/symbol in the second example.

When a slot/symbol is semi-statically configured to be flexible and is indicated to include an uplink part based on the uplink part time domain configuration, and it is dynamically indicated to be a downlink slot/symbol, the slot/symbol is a slot/symbol including an uplink part (or SBFD slot/symbol).

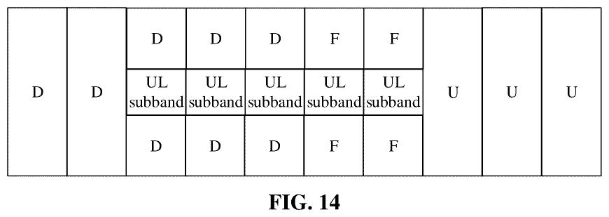

As illustrated in FIG. 10, FIG. 13, and FIG. 14, the slot 5 includes an uplink part in FIG. 10, the slot 5 is indicated through the SFI to be a downlink slot in FIG. 13, and the slot 5 is a slot including an uplink part in FIG. 14.

The information transmission on the slot/symbol is processed according to the configuration corresponding to the SBFD symbol. For example, for a slot including an uplink part, the uplink transmission is limited to the uplink part. For another example, the downlink transmission can only be performed in frequency domains other than the uplink part. For another example, the network configures two PUCCH-Configs for the terminal, where the PUCCH-Config 1 is used for the uplink part, and the PUCCH-Config 2 is used for the uplink slot. For the slot, the PUCCH resource is determined according to the PUCCH-Config 1.

Based on the above solution, the use of downlink resources can be maximized, and an unnecessary interference caused by receiving information in the uplink part can be avoided.

When a slot/symbol is semi-statically configured to be flexible and is indicated to include an uplink part based on the uplink part time domain configuration, and it is dynamically indicated to be an uplink slot/symbol, the slot/symbol is an uplink slot/symbol.

As illustrated in FIG. 10, FIG. 13, and FIG. 14, the slot 8 includes an uplink part in FIG. 10, the slot 8 is indicated through the SFI to be an uplink slot in FIG. 13, and the slot 8 is an uplink slot in FIG. 14.

The information transmission on the slot/symbol is processed according to the configuration corresponding to the uplink slot/symbol. For example, the uplink transmission may be scheduled on the entire BWP bandwidth. For another example, the network configures two PUCCH-Configs for the terminal, where the PUCCH-Config 1 is used for the uplink part, and the PUCCH-Config 2 is used for the uplink slot. For the slot, the PUCCH resource is determined according to the PUCCH-Config 2. In this way, the use of uplink resources is maximized.

In the above example, the wireless communication method of the present disclosure is described taking the uplink part as an example. In the embodiments of the present disclosure, the first configuration information may be used to indicate a slot/symbol including a downlink part (downlink sub-band). In this case, the first configuration information may be a downlink part time domain configuration.

The downlink part time domain configuration is used for indicating the downlink part and a slot/symbol including the downlink part (indicating SBFD).

For the indication mode in which the downlink part time domain configuration indicates the slot/symbol including the downlink part, the reference may be made to the indication mode in which the uplink part time domain configuration indicates the slot/symbol including the uplink part.

In a case that the terminal device receives the downlink part time domain configuration and the uplink-downlink configuration, and a slot/symbol is indicated by the downlink part time domain configuration to include the downlink part and is indicated by the uplink-downlink configuration, the terminal device determines a type or transmission mode of the slot/symbol based on the downlink part time domain configuration, or based on the downlink part time domain configuration and the uplink-downlink configuration.

In a case that the terminal device determines the type or the transmission mode based on the downlink part time domain configuration, the slot/symbol includes the downlink part. For a slot/symbol including the downlink part, the downlink transmission is limited to the downlink part. For another example, the uplink transmission can only be performed in frequency domains other than the downlink part. For another example, the network configures for the terminal two PDCCH configurations (PDCCH-Config): PDCCH-Config 1 and PDCCH-Config 2, where the PDCCH-Config 1 is used for the downlink part, and the PDCCH-Config 2 is used for the downlink slot/flexible slot. For the slot/symbol including the downlink part, the PDCCH resource is determined by using the PDCCH-Config 1. For the downlink slot/symbol, the PDCCH resource is determined by using the PDCCH-Config 2.

In a case that the terminal device determines the type or transmission mode of the slot/symbol based on the downlink part time domain configuration and the uplink-downlink configuration, the slot/symbol is one of the following cases: B1, B2, B3.

In the case B1, the slot/symbol is a downlink slot/symbol.

The information transmission on the slot/symbol is processed according to the configuration corresponding to the downlink slot/symbol. For example, the downlink transmission may be scheduled on the entire BWP bandwidth.

In the case B2, the slot/symbol is a slot/symbol including a downlink part.

The information transmission on the slot/symbol is processed according to the configuration corresponding to the slot/symbol including the downlink part. For example, for the slot/symbol including a downlink part, the downlink transmission is limited to the downlink part. For another example, the uplink transmission can only be performed in frequency domains other than the downlink part.

In the case B3, the slot/symbol is determined to be a downlink slot/symbol or a slot/symbol including a downlink part according to a scheduling situation.

In a method 3.1B, the slot/symbol is determined to be a downlink slot/symbol or a slot/symbol including a downlink part according to the scheduling situation and a frequency domain relationship between the downlink resource and the downlink part.

In a method 3.1.1B, if the slot/symbol is scheduled for PUSCH, then the slot/symbol is a slot/symbol including a downlink part, and uplink data is received only in an area other than the downlink part in the slot/symbol.

In a method 3.1.2B, if the slot/symbol is scheduled for PDSCH or PDCCH, and the PDSCH resource or PDCCH resource is allocated to the frequency domain resource other than the downlink part, then the slot/symbol is a downlink slot/symbol, and the downlink transmission may be scheduled on the entire BWP bandwidth.

In a method 3.1.3B, if the slot/symbol is scheduled for PDSCH or PDCCH, and the PDSCH resource or PDCCH resource is allocated to the frequency domain resource only on the downlink part, then the slot/symbol is a slot/symbol including the downlink part, and the downlink transmission is only on the downlink part.

In a method 3.2B, the slot/symbol is determined to be a downlink symbol or a symbol including a downlink part according to a scheduling situation.

In a method 3.2.1B, if the slot/symbol is scheduled for PUSCH, then the slot/symbol is a slot/symbol including a downlink part, and uplink data is received only in an area other than the downlink part of the slot/symbol.

In a method 3.2.2B, if the slot/symbol is scheduled for the PDSCH or PDCCH, the slot/symbol is a downlink slot/symbol.

The downlink transmissions may be scheduled on the entire BWP bandwidth.

In a case that a slot/symbol is indicated to include the downlink part and is indicated to be a flexible slot/symbol, and it is dynamically indicated to be an uplink slot/symbol through the SFI, the slot/symbol is a slot/symbol including a downlink part.

In a case that a slot/symbol is indicated to include the downlink part and is indicated to be a flexible slot/symbol, and it is dynamically indicated to be a downlink slot/symbol through the SFI, the slot/symbol is a slot/symbol including a downlink part.

The preferred embodiments of the present disclosure have been described in detail above with reference to the accompanying drawings, but the present disclosure is not limited to the specific details in the above embodiments. Within the scope of the technical concept of the present disclosure, a variety of simple modifications can be made to the technical solutions of the present disclosure, and these simple modifications all belong to the scope of protection of the present disclosure. For example, various specific technical features described in the above detailed embodiments can be combined in any suitable manner without contradiction, and various possible combinations will not be described separately in the present disclosure in order to avoid unnecessary repetition. For example, various embodiments of the present disclosure may be combined arbitrarily as long as they do not contradict the idea of the present disclosure, and they should be regarded as the disclosure of the present disclosure as well. For another example, on the premise that there is no conflict, various embodiments described in the present disclosure and/or the technical features in various embodiments may be arbitrarily combined with the prior art, and the technical solutions obtained after the combination should also fall within the scope of protection of the present disclosure.

It should also be understood that in various method embodiments of the present disclosure, the size of the sequence numbers of the above processes does not mean the sequence of execution, and the sequence of execution of various processes should be determined by its function and internal logic, and should not constitute any limitation on the implementation of the embodiments of the present disclosure. In addition, in the embodiments of the present disclosure, the terms “downlink”, “uplink” and “sidelink” are used to indicate the transmission direction of signals or data. The “downlink” is used to indicate that the transmission direction of signals or data is the first direction transmitted from the station to the UE of the cell, the “uplink” is used to indicate that the transmission direction of signals or data is the second direction transmitted from the UE of the cell to the station, and the “sidelink” is used to indicate that the transmission direction of the signal or data is the third direction transmitted from the UE 1 to the UE 2. For example, “downlink signal” indicates that the transmission direction of the signal is the first direction. In addition, in the embodiments of the present disclosure, the term “and/or” is only used for describing an association relationship between associated objects, which represents that there may be three relationships. Specifically, A and/or B, may represent that A exists alone, A and B exist simultaneously, or B exists alone. In addition, the character “/” in the present disclosure generally represents that there is an “or” relationship between the associated objects.

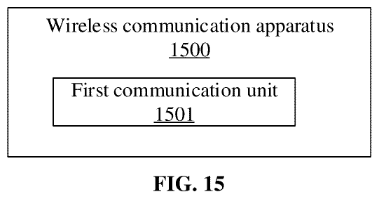

FIG. 15 is a schematic diagram of an optional structural composition of a wireless communication apparatus according to an embodiment of the present disclosure. The wireless communication apparatus is applied to a terminal device. As illustrated in FIG. 15, the wireless communication apparatus 1500 includes a first communication unit 1501.

The first communication unit 1501 is configured to receive first configuration information transmitted by a network device. The first configuration information is used to indicate a first time domain resource. The first time domain resource includes one or more time units, each time unit including a first frequency domain part in frequency domain. Herein, for any one time unit included in the first time domain resource, a transmission direction of the first frequency domain part is different from a transmission direction of the time unit configured by second configuration information. The second configuration information is used to configure a transmission direction for each time unit in one period.

In the embodiment of the present disclosure, the wireless communication apparatus 1500 may further include a storage unit. The storage unit is configured to store the second configuration information.

In some embodiments, the first configuration information is used to indicate at least one of:
whether each time unit within a first period belonging to the first time domain resource;
a first number, the first time domain resource including the first number of time units in the first period; or
a first position and the first number, the first time domain resource including the first number of time units in the first period with the first position as a starting position or an ending position.

In some embodiments, the first period is determined based on the second configuration information.

In some embodiments, a transmission mode of a target time unit belonging to the first time domain resource includes one of:
entire frequency domain resource of the target time unit being used for uplink transmission as a whole;
entire frequency domain resource of the target time unit being used for downlink transmission as a whole; and
a transmission mode of a first frequency domain part of the target time unit being independent of a transmission mode of a second frequency domain part of the target time unit, the second frequency domain part being a frequency domain part of the target time unit other than the first frequency domain part.

In some embodiments, the transmission mode of the target time unit is determined based on the first configuration information.

In some embodiments, the transmission mode of the first frequency domain part of the target time unit is independent of the transmission mode of the second frequency domain part.

In some embodiments, the transmission mode of the target time unit is determined based on the first configuration information and the second configuration information.

In some embodiments, the transmission mode of the target time unit is determined by at least one of following modes:
if the first frequency domain part is used for uplink transmission, and a transmission direction of the target time unit is configured to be uplink by the second configuration information, the entire frequency domain resource of the target time unit being used for uplink transmission as a whole;
if the first frequency domain part is used for uplink transmission, and the transmission direction of the target time unit is configured to be downlink by the second configuration information, the transmission mode of the first frequency domain part being independent of the transmission mode of the second frequency domain part, and the second frequency domain part being used for downlink transmission;
if the first frequency domain part is used for uplink transmission, and the transmission direction of the target time unit is configured to be flexible by the second configuration information, the entire frequency domain resource of the target time unit being used for uplink transmission as a whole;
if the first frequency domain part is used for uplink transmission and the transmission direction of the target time unit is configured to be flexible by the second configuration information, the transmission mode of the first frequency domain part being independent of the transmission mode of the second frequency domain part;
if the first frequency domain part is used for uplink transmission, the transmission direction of the target time unit is configured to be flexible by the second configuration information, and the target time unit is scheduled for uplink transmission, the entire frequency domain resource of the target time unit being used for uplink transmission as a whole;
if the first frequency domain part is used for uplink transmission, the transmission direction of the target time unit is configured to be flexible by the second configuration information, the target time unit is scheduled for uplink transmission, and a first frequency domain resource is located within the first frequency domain part, the transmission mode of the first frequency domain part being independent of the transmission mode of the second frequency domain part, the first frequency domain resource being a frequency domain resource of the target time unit in frequency domain that is used for uplink transmission;
if the first frequency domain part is used for uplink transmission, the transmission direction of the target time unit is configured to be flexible by the second configuration information, the target time unit is scheduled for uplink transmission, and the first frequency domain resource occupies the second frequency domain part of the target time unit, the transmission mode of the first frequency domain part being independent of the transmission mode of the second frequency domain part;
if the first frequency domain part is used for uplink transmission, the transmission direction of the target time unit is configured to be flexible by the second configuration information, the target time unit is scheduled for uplink transmission, and the first frequency domain resource occupies the first frequency domain part and the second frequency domain part of the target time unit, the entire frequency domain of the target time unit being used for uplink transmission as a whole; or
if the first frequency domain part is used for uplink transmission, the transmission direction of the target time unit is configured to be flexible by the second configuration information, and the target time unit is scheduled for downlink transmission, the transmission mode of the first frequency domain part being independent of the transmission mode of the second frequency domain part, and the second frequency domain part being used for downlink transmission.

In some embodiments, the transmission mode of the target time unit is determined by at least one of following modes:
if the first frequency domain part is used for downlink transmission, and the transmission direction of the target time unit is configured to be downlink by the second configuration information, the entire frequency domain resource of the target time unit being used for downlink transmission as a whole;
if the first frequency domain part is used for downlink transmission, and the transmission direction of the target time unit is configured to be uplink by the second configuration information, the transmission mode of the first frequency domain part being independent of the transmission mode of the second frequency domain part, and the second frequency domain part being used for uplink transmission;
if the first frequency domain part is used for downlink transmission, and the transmission direction of the target time unit is configured to be flexible by the second configuration information, the entire frequency domain resource of the target time unit being used for downlink transmission as a whole;
if the first frequency domain part is used for downlink transmission, and the transmission direction of the target time unit is configured to be flexible by the second configuration information, the transmission mode of the first frequency domain part being independent of the transmission mode of the second frequency domain part;
if the first frequency domain part is used for downlink transmission, the transmission direction of the target time unit is configured to be flexible by the second configuration information, and the target time unit is scheduled for downlink transmission, the entire frequency domain resource of the target time unit being used for downlink transmission as a whole;
if the first frequency domain part is used for downlink transmission, the transmission direction of the target time unit is configured to be flexible by the second configuration information, the target time unit is scheduled for downlink transmission, and a second frequency domain resource is located within the first frequency domain part, the transmission mode of the first frequency domain part being independent of the transmission mode of the second frequency domain part, the second frequency domain resource being a frequency domain resource of the target time unit in frequency domain that is used for downlink transmission;
if the first frequency domain part is used for downlink transmission, the transmission direction of the target time unit is configured to be flexible by the second configuration information, the target time unit is scheduled for downlink transmission, and the second frequency domain resource occupies the second frequency domain part, the transmission mode of the first frequency domain part being independent of the transmission mode of the second frequency domain part;
if the first frequency domain part is used for downlink transmission, the transmission direction of the target time unit is configured to be flexible by the second configuration information, the target time unit is scheduled for downlink transmission, and the second frequency domain resource occupies the first frequency domain part and the second frequency domain part, the entire frequency domain resource of the target time unit being used for downlink transmission as a whole; or
if the first frequency domain part is used for downlink transmission, the transmission direction of the target time unit is configured to be flexible by the second configuration information, and the target time unit is scheduled for uplink transmission, the transmission mode of the first frequency domain part being independent of the transmission mode of the second frequency domain part, and the second frequency domain part being used for uplink transmission.

In some embodiments, if the first frequency domain part is used for uplink transmission, a transmission direction of time units in the first time domain resource is configured to be downlink by the second configuration information.

Optionally, if the first frequency domain part is used for downlink transmission, the transmission direction of the time units in the first time domain resource is configured to be uplink by the second configuration information.

In some embodiments, the second configuration information includes at least one of:
uplink-downlink common configuration (UL-DL-ConfigCommon);
uplink-downlink dedicated configuration (UL-DL-ConfigDedicated); or
slot format indication (SFI).

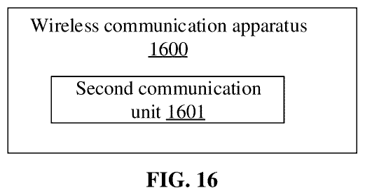

FIG. 16 is a schematic diagram of an optional structural composition of a wireless communication apparatus according to an embodiment of the present disclosure. The wireless communication apparatus is applied to a network device. As illustrated in FIG. 16, the wireless communication apparatus 1600 includes a second communication unit 1601.

The second communication unit 1601 is configured to transmit the first configuration information to a terminal device. The first configuration information is used to indicate a first time domain resource. The first time domain resource includes one or more time units, each time unit including a first frequency domain part in frequency domain. Herein, for any one time unit included in the first time domain resource, a transmission direction of the first frequency domain part is different from a transmission direction of the time unit configured by second configuration information. The second configuration information is used to configure a transmission direction for each time unit in one period.

In an embodiment of the present disclosure, the wireless communication apparatus 1600 may further include a configuration unit. The configuration unit is configured to determine the first configuration information.

In some embodiments, the first configuration information is used to indicate at least one of:
whether each time unit within a first period belonging to the first time domain resource;
a first number, the first time domain resource including the first number of time units in the first period; or
a first position and the first number, the first time domain resource including the first number of time units in the first period that use the first position as a starting position or an ending position.

In some embodiments, the first period is determined based on the second configuration information.

In some embodiments, a transmission mode of a target time unit belonging to the first time domain resource includes one of:
entire frequency domain resource of the target time unit being used for uplink transmission as a whole;
entire frequency domain resource of the target time unit being used for downlink transmission as a whole; and
a transmission mode of a first frequency domain part of the target time unit being independent of a transmission mode of a second frequency domain part of the target time unit, the second frequency domain part being a frequency domain part of the target time unit other than the first frequency domain part.

In some embodiments, the transmission mode of the target time unit is determined based on the first configuration information.

In some embodiments, the transmission mode of the first frequency domain part of the target time unit is independent of the transmission mode of the second frequency domain part of the target time unit.

In some embodiments, the transmission mode of the target time unit is determined based on the first configuration information and the second configuration information.

In some embodiments, the transmission mode of the target time unit is determined by at least one of following modes:
if the first frequency domain part is used for uplink transmission, and a transmission direction of the target time unit is configured to be uplink by the second configuration information, the entire frequency domain resource of the target time unit being used for uplink transmission as a whole;
if the first frequency domain part is used for uplink transmission, and the transmission direction of the target time unit is configured to be downlink by the second configuration information, the transmission mode of the first frequency domain part being independent of the transmission mode of the second frequency domain part, and the second frequency domain part being used for downlink transmission;
if the first frequency domain part is used for uplink transmission, and the transmission direction of the target time unit is configured to be flexible by the second configuration information, the entire frequency domain resource of the target time unit being used for uplink transmission as a whole;
if the first frequency domain part is used for uplink transmission, and the transmission direction of the target time unit is configured to be flexible by the second configuration information, the transmission mode of the first frequency domain part being independent of the transmission mode of the second frequency domain part;
if the first frequency domain part is used for uplink transmission, the transmission direction of the target time unit is configured to be flexible by the second configuration information, and the target time unit is scheduled for uplink transmission, the entire frequency domain resource of the target time unit being used for uplink transmission as a whole;
if the first frequency domain part is used for uplink transmission, the transmission direction of the target time unit is configured to be flexible by the second configuration information, the target time unit is scheduled for uplink transmission, and a first frequency domain resource is located within the first frequency domain part, the transmission mode of the first frequency domain part being independent of the transmission mode of the second frequency domain part, the first frequency domain resource being a frequency domain resource of the target time unit in frequency domain that is used for uplink transmission;
if the first frequency domain part is used for uplink transmission, the transmission direction of the target time unit is configured to be flexible by the second configuration information, the target time unit is scheduled for uplink transmission, and the first frequency domain resource occupies the second frequency domain part of the target time unit, the transmission mode of the first frequency domain part being independent of the transmission mode of the second frequency domain part;
if the first frequency domain part is used for uplink transmission, the transmission direction of the target time unit is configured to be flexible by the second configuration information, the target time unit is scheduled for uplink transmission, and the first frequency domain resource occupies the first frequency domain part and the second frequency domain part of the target time unit, the entire frequency domain of the target time unit being used for uplink transmission as a whole; or
if the first frequency domain part is used for uplink transmission, the transmission direction of the target time unit is configured to be flexible by the second configuration information, and the target time unit is scheduled for downlink transmission, the transmission mode of the first frequency domain part being independent of the transmission mode of the second frequency domain part, and the second frequency domain part being used for downlink transmission.

In some embodiments, the transmission mode of the target time unit is determined by at least one of following modes:
if the first frequency domain part is used for downlink transmission, and the transmission direction of the target time unit is configured to be downlink by the second configuration information, the entire frequency domain resource of the target time unit being used for downlink transmission as a whole;
if the first frequency domain part is used for downlink transmission, and the transmission direction of the target time unit is configured to be uplink by the second configuration information, the transmission mode of the first frequency domain part being independent of the transmission mode of the second frequency domain part, and the second frequency domain part being used for uplink transmission;
if the first frequency domain part is used for downlink transmission, and the transmission direction of the target time unit is configured to be flexible by the second configuration information, the entire frequency domain resource of the target time unit being used for downlink transmission as a whole;
if the first frequency domain part is used for downlink transmission, and the transmission direction of the target time unit is configured to be flexible by the second configuration information, the transmission mode of the first frequency domain part being independent of the transmission mode of the second frequency domain part;
if the first frequency domain part is used for downlink transmission, the transmission direction of the target time unit is configured to be flexible by the second configuration information, and the target time unit is scheduled for downlink transmission, the entire frequency domain resource of the target time unit being used for downlink transmission as a whole;
if the first frequency domain part is used for downlink transmission, the transmission direction of the target time unit is configured to be flexible by the second configuration information, the target time unit is scheduled for downlink transmission, and a second frequency domain resource is located within the first frequency domain part, the transmission mode of the first frequency domain part being independent of the transmission mode of the second frequency domain part, the second frequency domain resource being a frequency domain resource of the target time unit in frequency domain that is used for downlink transmission;
if the first frequency domain part is used for downlink transmission, the transmission direction of the target time unit is configured to be flexible by the second configuration information, the target time unit is scheduled for downlink transmission, and the second frequency domain resource occupies the second frequency domain part, the transmission mode of the first frequency domain part being independent of the transmission mode of the second frequency domain part;
if the first frequency domain part is used for downlink transmission, the transmission direction of the target time unit is configured to be flexible by the second configuration information, the target time unit is scheduled for downlink transmission, and the second frequency domain resource occupies the first frequency domain part and the second frequency domain part, the entire frequency domain resource of the target time unit being used for downlink transmission as a whole; or
if the first frequency domain part is used for downlink transmission, the transmission direction of the target time unit is configured to be flexible by the second configuration information, and the target time unit is scheduled for uplink transmission, the transmission mode of the first frequency domain part being independent of the transmission mode of the second frequency domain part, and the second frequency domain part being used for uplink transmission.

In some embodiments, if the first frequency domain part is used for uplink transmission, a transmission direction of time units in the first time domain resource is configured to be downlink by the second configuration information.

Optionally, if the first frequency domain part is used for downlink transmission, the transmission direction of the time units in the first time domain resource is configured to be uplink by the second configuration information.

In some embodiments, the second configuration information includes at least one of:
uplink-downlink common configuration (UL-DL-ConfigCommon).
uplink-downlink dedicated configuration (UL-DL-ConfigDedicated); or
slot format indication (SFI)

Those skilled in the art should understand that the related description of the above wireless communication apparatus according to the embodiments of the present disclosure may be understood with reference to the related description of the wireless communication method according to the embodiments of the present disclosure.

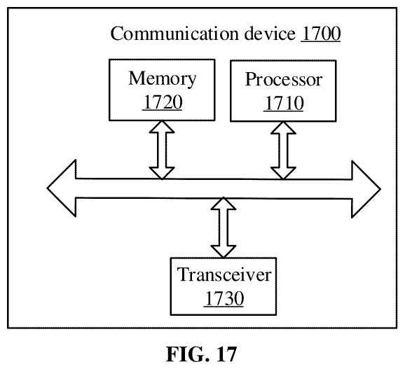

FIG. 17 is a schematic diagram of a structure of a communication device 1700 provided by an embodiment of the present disclosure. The communication device may be a terminal device or a network device. The communication device 1700 illustrated in FIG. 17 includes a processor 1710. The processor 1710 is configured to invoke and execute a computer program from a memory to implement the method in the embodiments of the present disclosure.

In some embodiments, as illustrated in FIG. 17, the communication device 1700 may further include a memory 1720. The processor 1710 may be configured to invoke and execute a computer program from the memory 1720 to implement the method in the embodiments of the present disclosure.

The memory 1720 may be a separate device independent of the processor 1710 or may be integrated in the processor 1710.

In some embodiments, as illustrated in FIG. 17, the communication device 1700 may further include a transceiver 1730. The processor 1710 may control the transceiver 1730 to communicate with other devices, in particular, may transmit information or data to or receive information or data transmitted by other devices.

The transceiver 1730 may include a transmitter and a receiver. The transceiver 1730 may further include one or more antennas.

In some embodiments, the communication device 1700 may specifically be the network device according to the embodiments of the present disclosure, and the communication device 1700 may implement corresponding processes implemented by the network device in various methods according to the embodiments of the present disclosure, which will not be described herein for the sake of conciseness.

In some embodiments, when the communication device 1700 is the network device according to the embodiment of the present disclosure, the processor 1710 may be implemented as a configuration module in the wireless communication apparatus 1600, and the transceiver 1730 may be implemented as the second communication unit in the wireless communication apparatus 1600.

In some embodiments, the communication device 1700 may specifically be the mobile terminal/terminal device according to the embodiments of the present disclosure, and the communication device 1700 may implement corresponding processes implemented by the mobile terminal/terminal device in various methods according to the embodiments of the present disclosure, which will not be described herein for the sake of conciseness.

In some embodiments, when the communication device 1700 is the terminal device according to the embodiment of the present disclosure, the memory 1720 may be implemented as a storage module in the wireless communication apparatus 1500, and the transceiver 1730 may be implemented as the first communication unit in the wireless communication apparatus 1500.

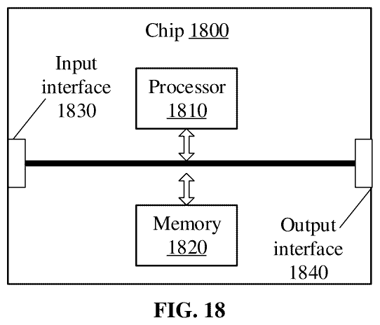

FIG. 18 is a schematic diagram of a structure of a chip according to an embodiment of the present disclosure. The chip 1800 illustrated in FIG. 18 includes a processor 1810, which may invoke and execute a computer program from a memory to implement the methods in the embodiments of the present disclosure.

In some embodiments, as illustrated in FIG. 18, the chip 1800 may further include a memory 1820. The processor 1810 may invoke and execute a computer program from the memory 1820 to implement the methods in the embodiments of the present disclosure.

The memory 1820 may be a separate device independent of the processor 1810 or may be integrated in the processor 1810.

In some embodiments, the chip 1800 may further include an input interface 1830. The processor 1810 may control the input interface 1830 to communicate with other devices or chips, specifically, may acquire information or data transmitted by other devices or chips.

In some embodiments, the chip 1800 may further include an output interface 1840. The processor 1810 may control the output interface 1840 to communicate with other devices or chips, specifically, may output information or data to other devices or chips.

In some embodiments, the chip may be applied to the network device in the embodiments of the present disclosure, and the chip may implement corresponding processes implemented by the network device in various methods of the embodiments of the present disclosure, which will not be described herein for the sake of conciseness.

In some embodiments, the chip may be applied to the mobile terminal/terminal device in the embodiments of the present disclosure, and the chip may implement corresponding processes implemented by the mobile terminal/terminal device in various methods of the embodiments of the present disclosure, which will not be described herein for the sake of conciseness.

It should be understood that the chip mentioned in the embodiment of the present disclosure may also be referred to as a system level chip, a system chip, a chip system or a system-on-chip or the like.

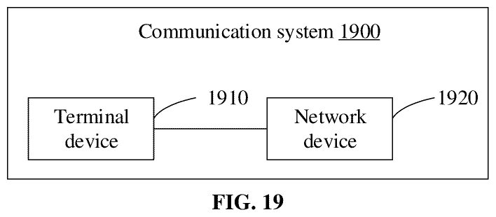

FIG. 19 is a schematic block diagram of a communication system 1900 provided by an embodiment of the present disclosure. As illustrated in FIG. 19, the communication system 1900 includes a terminal device 1910 and a network device 1920.

The terminal device 810 may be used to implement the corresponding functions implemented by the terminal device in the above methods, and the network device 820 may be configured to implement the corresponding functions implemented by the network device in the above methods, which will not be described herein for the sake of conciseness.

It should be understood that the processor of the embodiments of the present disclosure may be an integrated circuit chip having signal processing capabilities. In the implementation process, the operations of the above method embodiments may be completed by integrated logic circuits of hardware in the processor or instructions in the form of software. The processor described above may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, operations, and logical block diagrams disclosed in the embodiments of the present disclosure may be implemented or executed. The general-purpose processor may be a microprocessor or the processor may be any conventional processor or the like. The operations of the method disclosed in combination with the embodiments of the present disclosure may be directly embodied as execution by the hardware decoding processor, or may be executed by a combination of hardware and software modules in the decoding processor. The software module may be located in a Random Access Memory (RAM), a flash memory, a Read-Only Memory (ROM), a Programmable ROM (PROM), an electrically erasable PROM (EEPROM), a register and other storage medium mature in the art. The storage medium is located in the memory, and the processor reads the information in the memory and completes the operations of the methods in combination with its hardware.

It is understood that the memory in the embodiments of the present disclosure may be a volatile memory or a non-volatile memory, or may include both volatile and non-volatile memory. The non-volatile memory may be a ROM, a PROM, an Erasable PROM (EPROM), an EEPROM, or a flash memory. The volatile memory may be a RAM, which serves as an external cache. By way of illustration, but not limitation, many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM) and Direct Rambus RAM (DR RAM). It should be noted that the memory of the systems and methods described herein is intended to include, but is not limited to, these and any other suitable type of memory.

It should be understood that the above memory is exemplary, but not limiting, and, for example, the memory in embodiments of the present disclosure may also be an SRAM, a DRAM, an SDRAM, a DDR SDRAM, an ESDRAM, an SLDRAM, a DR RAM, etc. That is, the memory in embodiments of the present disclosure is intended to include but not limited to these and any other suitable types of memory.

Embodiments of the present disclosure further provide a computer readable storage medium for storing a computer program.

In some embodiments, the computer readable storage medium may be applied to the mobile terminal/terminal device in the embodiments of the present disclosure, and when the computer program is executed, the computer performs the corresponding flow implemented by the mobile terminal/terminal device in various methods of the embodiments of the present disclosure, which will not be described herein for the sake of conciseness.

In some embodiments, the computer readable storage medium may be applied to the network device in the embodiment of the present disclosure, and the computer program, when executed, causes a computer to perform the corresponding flow implemented by the network device in various methods of the embodiments of the present disclosure, which will not be described herein for the sake of conciseness.

Embodiments of the present disclosure further provide a computer program product including computer program instructions.

In some embodiments, the computer program product may be applied to the mobile terminal/terminal device in the embodiments of the present disclosure, and the computer program instruction, when executed, causes a computer to perform the corresponding flow implemented by the mobile terminal/terminal device in various methods of the embodiments of the present disclosure, which will not be described herein for the sake of conciseness.

In some embodiments, the computer program product may be applied to the network device in the embodiments of the present disclosure, and the computer program instructions, when executed on a computer, cause the computer to perform the corresponding flow implemented by the network device in various methods of the embodiments of the present disclosure, which will not be described herein for the sake of conciseness.

Embodiments of the present disclosure further provide a computer program.

In some embodiments, the computer program may be applied to the mobile terminal/terminal device in the embodiments of the present disclosure, and the computer program, when executed on a computer, causes the computer to perform the corresponding flow implemented by the mobile terminal/terminal device in various methods of the embodiments of the present disclosure, which will not be described herein for the sake of conciseness.

In some embodiments, the computer program may be applied to the network device in the embodiments of the present disclosure, and the computer program, when executed on a computer, causes the computer to perform the corresponding flow implemented by the network device in various methods of the embodiments of the present disclosure, which will not be described herein for the sake of conciseness.

Those of ordinary skill in the art will appreciate that the various exemplary units and algorithm steps described in combination with the embodiments disclosed herein may be implemented in electronic hardware or a combination of computer software and electronic hardware. Whether these functions are performed in hardware or software depends on the specific application and design constraints of the technical solutions. Professionals may use different methods for each particular application to implement the described functionality, but such implementation should not be considered outside the scope of the present disclosure.

Those skilled in the art will clearly appreciate that, for convenience and conciseness of description, the specific operating processes of the above described systems, apparatuses and units may refer to the corresponding processes in the aforementioned method embodiments, which will not be described herein for the sake of conciseness.

In several embodiments provided herein, it should be understood that the disclosed systems, apparatuses and methods may be implemented in other ways. For example, the above embodiments of the apparatuses are only schematic, for example, the division of the units is only a logical function division, and in practice, there may be another division mode, for example, multiple units or components may be combined or integrated into another system, or some features may be ignored or not performed. On the other hand, the coupling, direct coupling or communication connection between each other shown or discussed may be indirect coupling or communication connection through some interfaces, apparatus or units, and may be electrical, mechanical or other form.

The units illustrated as separate components may or may not be physically separated, and the components displayed as units may or may not be physical units, i.e., may be located in one place, or may be distributed over multiple network units. Part or all of the units may be selected according to the actual needs to achieve the purpose of the embodiments.

In addition, various functional units in various embodiments of the present disclosure may be integrated in one processing unit, each unit may exist physically alone, or two or more units may be integrated in one unit.

When implemented in the form of software functional units, and sold or used as stand-alone products, the functions may be stored in a computer readable storage medium. With this understanding, the technical solution of the present disclosure in essence or in part contributing to the prior art may be embodied in the form of a software product. The computer software product is stored in a storage medium, and includes instructions for causing a computer device (which may be a personal computer, a server, a network device, etc.) to perform all or part of the steps of the methods described in various embodiments of the present disclosure. The above storage medium includes a U disk, a removable hard disk, a ROM, a RAM, a magnetic disk or an optical disk and other medium capable of storing program codes.

The above is only the specific embodiments of the present disclosure, but the scope of protection of the present disclosure is not limited thereto. Any technical person familiar with the technical field can easily think of changes or substitutions within the technical scope disclosed in the present disclosure, which should be covered within the scope of protection of the present disclosure. Therefore, the scope of protection of the present disclosure shall be subject to the scope of protection of the claims.

1. A wireless communication method, comprising:
receiving, by a terminal device, first configuration information transmitted by a network device, wherein the first configuration information is used to indicate a first time domain resource, and the first time domain resource comprises one or more time units, each time unit comprising a first frequency domain part in frequency domain, wherein for any one time unit comprised in the first time domain resource, a transmission direction of the first frequency domain part is different from a transmission direction of the time unit configured by second configuration information, and the second configuration information is used to configure a transmission direction for each of time units in one period.

2. The method of claim 1, wherein the first configuration information is used to indicate at least one of:
whether each of time units within a first period belonging to the first time domain resource;
a first number, wherein the first time domain resource comprises the first number of time units in the first period; or
a first position and the first number, wherein the first time domain resource comprises the first number of time units in the first period with the first position as a starting position or an ending position,
wherein the first period is determined based on the second configuration information.

3. The method of claim 1, wherein a transmission mode of a target time unit belonging to the first time domain resource comprises one of:
entire frequency domain resource of the target time unit being used for uplink transmission as a whole;
entire frequency domain resource of the target time unit being used for downlink transmission as a whole; and
a transmission mode of a first frequency domain part of the target time unit being independent of a transmission mode of a second frequency domain part of the target time unit, wherein the second frequency domain part is a frequency domain part of the target time unit other than the first frequency domain part.

4. The method of claim 3, wherein the transmission mode of the target time unit is determined based on the first configuration information.

5. The method of claim 4, wherein the transmission mode of the first frequency domain part of the target time unit is independent of the transmission mode of the second frequency domain part of the target time unit.

6. The method of claim 3, wherein the transmission mode of the target time unit is determined based on the first configuration information and the second configuration information.

7. The method of claim 6, wherein the transmission mode of the target time unit is determined by at least one of following modes:
if the first frequency domain part is used for uplink transmission, and a transmission direction of the target time unit is configured to be uplink by the second configuration information, then the entire frequency domain resource of the target time unit being used for uplink transmission as a whole;
if the first frequency domain part is used for uplink transmission, and the transmission direction of the target time unit is configured to be downlink by the second configuration information, then the transmission mode of the first frequency domain part being independent of the transmission mode of the second frequency domain part, and the second frequency domain part being used for downlink transmission;
if the first frequency domain part is used for uplink transmission, and the transmission direction of the target time unit is configured to be flexible by the second configuration information, then the entire frequency domain resource of the target time unit being used for uplink transmission as a whole;
if the first frequency domain part is used for uplink transmission and the transmission direction of the target time unit is configured to be flexible by the second configuration information, then the transmission mode of the first frequency domain part being independent of the transmission mode of the second frequency domain part;
if the first frequency domain part is used for uplink transmission, the transmission direction of the target time unit is configured to be flexible by the second configuration information, and the target time unit is scheduled for uplink transmission, then the entire frequency domain resource of the target time unit being used for uplink transmission as a whole;
if the first frequency domain part is used for uplink transmission, the transmission direction of the target time unit is configured to be flexible by the second configuration information, the target time unit is scheduled for uplink transmission, and a first frequency domain resource is located within the first frequency domain part, then the transmission mode of the first frequency domain part being independent of the transmission mode of the second frequency domain part, wherein the first frequency domain resource is a frequency domain resource of the target time unit in frequency domain that is used for uplink transmission;
if the first frequency domain part is used for uplink transmission, the transmission direction of the target time unit is configured to be flexible by the second configuration information, the target time unit is scheduled for uplink transmission, and the first frequency domain resource occupies the second frequency domain part of the target time unit, then the transmission mode of the first frequency domain part being independent of the transmission mode of the second frequency domain part;
if the first frequency domain part is used for uplink transmission, the transmission direction of the target time unit is configured to be flexible by the second configuration information, the target time unit is scheduled for uplink transmission, and the first frequency domain resource occupies the first frequency domain part and the second frequency domain part of the target time unit, then the entire frequency domain of the target time unit being used for uplink transmission as a whole; or
if the first frequency domain part is used for uplink transmission, the transmission direction of the target time unit is configured to be flexible by the second configuration information, and the target time unit is scheduled for downlink transmission, then the transmission mode of the first frequency domain part being independent of the transmission mode of the second frequency domain part, and the second frequency domain part being used for downlink transmission.

8. The method of claim 1, wherein the second configuration information comprises at least one of:
uplink-downlink common configuration (UL-DL-ConfigCommon);
uplink-downlink dedicated configuration (UL-DL-ConfigDedicated); or
slot format indication (SFI).

9. A wireless communication apparatus, comprising:
a transceiver, configured to receive first configuration information transmitted by a network device, wherein the first configuration information is used to indicate a first time domain resource, and the first time domain resource comprises one or more time units, each time unit comprising a first frequency domain part in frequency domain, wherein for any one time unit comprised in the first time domain resource, a transmission direction of the first frequency domain part is different from a transmission direction of the time unit configured by second configuration information, and the second configuration information is used to configure a transmission direction for each of time units in one period.

10. The apparatus of claim 9, wherein the first configuration information is used to indicate at least one of:
whether each of time units within a first period belonging to the first time domain resource;
a first number, wherein the first time domain resource comprises the first number of time units in the first period; or
a first position and the first number, wherein the first time domain resource comprises the first number of time units in the first period with the first position as a starting position or an ending position,
wherein the first period is determined based on the second configuration information.

11. The apparatus of claim 9, wherein a transmission mode of a target time unit belonging to the first time domain resource comprises one of:
entire frequency domain resource of the target time unit being used for uplink transmission as a whole;
entire frequency domain resource of the target time unit being used for downlink transmission as a whole; and
a transmission mode of a first frequency domain part of the target time unit being independent of a transmission mode of a second frequency domain part of the target time unit, wherein the second frequency domain part is a frequency domain part of the target time unit other than the first frequency domain part.

12. The apparatus of claim 11, wherein the transmission mode of the target time unit is determined based on the first configuration information.

13. The apparatus of claim 12, wherein the transmission mode of the first frequency domain part of the target time unit is independent of the transmission mode of the second frequency domain part of the target time unit.

14. The apparatus of claim 11, wherein the transmission mode of the target time unit is determined based on the first configuration information and the second configuration information.

15. The apparatus of claim 14, wherein the transmission mode of the target time unit is determined by at least one of following modes:
if the first frequency domain part is used for uplink transmission, and a transmission direction of the target time unit is configured to be uplink by the second configuration information, then the entire frequency domain resource of the target time unit being used for uplink transmission as a whole;
if the first frequency domain part is used for uplink transmission, and the transmission direction of the target time unit is configured to be downlink by the second configuration information, then the transmission mode of the first frequency domain part being independent of the transmission mode of the second frequency domain part, and the second frequency domain part being used for downlink transmission;
if the first frequency domain part is used for uplink transmission, and the transmission direction of the target time unit is configured to be flexible by the second configuration information, then the entire frequency domain resource of the target time unit being used for uplink transmission as a whole;
if the first frequency domain part is used for uplink transmission and the transmission direction of the target time unit is configured to be flexible by the second configuration information, then the transmission mode of the first frequency domain part being independent of the transmission mode of the second frequency domain part;
if the first frequency domain part is used for uplink transmission, the transmission direction of the target time unit is configured to be flexible by the second configuration information, and the target time unit is scheduled for uplink transmission, then the entire frequency domain resource of the target time unit being used for uplink transmission as a whole;
if the first frequency domain part is used for uplink transmission, the transmission direction of the target time unit is configured to be flexible by the second configuration information, the target time unit is scheduled for uplink transmission, and a first frequency domain resource is located within the first frequency domain part, then the transmission mode of the first frequency domain part being independent of the transmission mode of the second frequency domain part, wherein the first frequency domain resource is a frequency domain resource of the target time unit in frequency domain that is used for uplink transmission;
if the first frequency domain part is used for uplink transmission, the transmission direction of the target time unit is configured to be flexible by the second configuration information, the target time unit is scheduled for uplink transmission, and the first frequency domain resource occupies the second frequency domain part of the target time unit, then the transmission mode of the first frequency domain part being independent of the transmission mode of the second frequency domain part;
if the first frequency domain part is used for uplink transmission, the transmission direction of the target time unit is configured to be flexible by the second configuration information, the target time unit is scheduled for uplink transmission, and the first frequency domain resource occupies the first frequency domain part and the second frequency domain part of the target time unit, then the entire frequency domain of the target time unit being used for uplink transmission as a whole; or
if the first frequency domain part is used for uplink transmission, the transmission direction of the target time unit is configured to be flexible by the second configuration information, and the target time unit is scheduled for downlink transmission, then the transmission mode of the first frequency domain part being independent of the transmission mode of the second frequency domain part, and the second frequency domain part being used for downlink transmission.

16. A wireless communication apparatus, comprising:
a transceiver, configured to transmit first configuration information to a terminal device, wherein the first configuration information is used to indicate a first time domain resource, and the first time domain resource comprises one or more time units, each time unit comprising a first frequency domain part in frequency domain, wherein for any one time unit comprised in the first time domain resource, a transmission direction of the first frequency domain part is different from a transmission direction of the time unit configured by second configuration information, and the second configuration information is used to configure a transmission direction for each of time units in one period.

17. The apparatus of claim 16, wherein the first configuration information is used to indicate at least one of:
whether each of time units within a first period belonging to the first time domain resource;
a first number, wherein the first time domain resource comprises the first number of time units in the first period; or
a first position and the first number, wherein the first time domain resource comprises the first number of time units in the first period with the first position as a starting position or an ending position,
wherein the first period is determined based on the second configuration information.

18. The apparatus of claim 16, wherein a transmission mode of a target time unit belonging to the first time domain resource comprises one of:
entire frequency domain resource of the target time unit being used for uplink transmission as a whole;
entire frequency domain resource of the target time unit being used for downlink transmission as a whole; and
a transmission mode of a first frequency domain part being independent of a transmission mode of a second frequency domain part, wherein the second frequency domain part is a frequency domain part of the target time unit other than the first frequency domain part.

19. The apparatus of claim 18, wherein the transmission mode of the target time unit is determined based on the first configuration information.

20. The apparatus of claim 18, wherein the transmission mode of the target time unit is determined based on the first configuration information and the second configuration information.
